(19) United States
(12) Patent Application Publication
(10) Pub. No.: US 2015/0380136 A1
(43) Pub. Date: Dec. 31, 2015

(54) IRON-BASED SOFT MAGNETIC MATERIAL AND IRON-BASED SOFT MAGNETIC CORE

(71) Applicants: Aisin Seiki Kabushiki Kaisha, Kariya-shi (JP); Aisin Takaoka Co., Ltd., Toyota (JP)

(72) Inventors: Makoto TSUKAHARA, Kariya-shi (JP); Mio BAN, Kosai-shi (JP); Takeshi SEO, Toyota-shi (JP); Zhong-zhi ZHANG, Kariya-shi (JP)

(73) Assignees: Aisin Seiki Kabushiki Kaisha, Kariya-shi (JP); Aisin Takaoka Co., Ltd., Toyota (JP)

(21) Appl. No.: 14/755,307

(22) Filed: Jun. 30, 2015

(30) Foreign Application Priority Data
Jun. 30, 2014 (JP) 2014-133613
May 18, 2015 (JP) 2015-101060

(51) Int. Cl. H01F 1/147; H01F 41/02; C22C 38/02; C21D 1/18; C22C 38/16; C22C 38/60

(52) U.S. Cl. CPC H01F 1/14766; C22C 38/16; C22C 38/60; C22C 38/02; C21D 1/18; H01F 41/02

(57) ABSTRACT

The iron-based soft magnetic material includes: a parent phase containing iron as a main component; and a grain boundary phase present in a crystal grain boundary of the parent phase, the grain boundary phase containing as a main component a sulfide containing copper.

This application is based on and claims priority under 35 U.S.C §119 to Japanese Patent Application No. 2014-133613 filed on Jun. 30, 2014, and Japanese Patent Application No. 2015-101060 filed on May 18, 2015, the entire content of which is incorporated herein by references.

### TECHNICAL FIELD

This disclosure relates to an iron-based soft magnetic material and an iron-based soft magnetic core.

### BACKGROUND DISCUSSION

An iron-based soft magnetic material is widely used for a core of a motor, a transformer, a reactor, or the like. When an alternating-current magnetic field is applied to the core, an eddy current is generated. In order to reduce an electrical energy loss due to the eddy current to be generated (eddy current loss), the iron-based soft magnetic material is required to have a high electrical resistance.

Japanese Patent Application Laid-open No. 2004-327762 (Reference 1) discloses a complex soft magnetic material including a substance having a high electrical resistance (high specific resistance substance) and metal soft magnetic materials, in which the high specific resistance substance forms a continuous structure while isolating the metal soft magnetic materials from each other. According to Reference 1, the metal soft magnetic materials are each selected from at least one kind of pure iron, an iron-nickel alloy, an iron-nickel-molybdenum alloy, an iron-silicon alloy, or an iron-silicon-aluminum alloy. In addition, the high specific resistance substance is formed of: at least one kind selected from constituent elements of the metal soft magnetic materials; and at least one kind of B, P, or S. Japanese Patent Application Laid-open No. 2005-347430 (Reference 2) discloses a magnetic core material for an alternating current including a material having a structure in which iron-silicon-based or iron-cobalt-based metal ferromagnetic phases are separated from each other by a semiconductor phase (high specific resistance substance) formed of FeS.

### SUMMARY

The specific resistance of the high specific resistance substance in the iron-based soft magnetic material disclosed in Reference 1 and the specific resistance of the semiconductor phase in the iron-based soft magnetic material disclosed in Reference 2 are not so high. Therefore, when an alternating-current magnetic field is applied to the iron-based soft magnetic materials disclosed in References 1 and 2, an eddy current loss to be generated cannot be sufficiently reduced.

A need thus exists for the iron-based soft magnetic materials which is not susceptible to the drawback mentioned above.

According to one embodiment of this disclosure, there is provided an iron-based soft magnetic material, including: a parent phase containing iron as a main component; and a grain boundary phase present in a crystal grain boundary of the parent phase, the grain boundary phase containing as a main component a sulfide containing copper.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a ternary composition diagram of the atomic concentrations of iron and a constituent component of a parent phase other than iron (Fe+β), copper (Cu), and sulfur (S);

FIG. 2 is a detail view of a portion G of FIG. 1;

FIG. 3 is a photograph for showing a polished sectional surface of an alloy produced by a method according to Example 1;

FIG. 4 is a graph for showing a measurement result with an X-ray diffractometer;

FIG. 5 is a schematic perspective view of a core produced by a casting method;

FIG. 6A and FIG. 6B are SEM images of a polished sectional surface of an ingot obtained by casting raw materials having atomic concentrations of iron, copper, and sulfur of 90.8 at % Fe-5.1 at % Cu-4.1 at % S;

FIG. 7 is an iron (Fe)-silicon (Si)-based equilibrium phase diagram;

FIG. 8 is a ternary composition diagram of the atomic concentrations of iron and silicon (Fe+Si), copper (Cu), and sulfur (S);

FIG. 9 is a detail view of a portion G of FIG. 8;

FIG. 10A and FIG. 10B are micrographs of a polished sectional surface of an alloy produced by using raw materials at a composition ratio shown in Example 2-1;

FIG. 11A and FIG. 11B are micrographs of a polished sectional surface of an alloy produced by using raw materials at a composition ratio shown in Example 2-2;

FIG. 12A and FIG. 12B are micrographs of a polished sectional surface of an alloy produced by using raw materials at a composition ratio shown in Example 2-3;

FIG. 13A and FIG. 13B are micrographs of a polished sectional surface of an alloy produced by using raw materials at a composition ratio shown in Example 2-4;

FIG. 14A and FIG. 14B are micrographs of a polished sectional surface of an alloy produced by using raw materials at a composition ratio shown in Comparative Example 1;

FIG. 15 is a ternary composition diagram of the atomic concentrations of iron and a constituent component of a parent phase other than iron (Fe+β), copper (Cu), and sulfur (S);

FIG. 16 is a backscattered electron image of a sectional surface of a sample alloy according to Example 3 with a scanning electron microscope;

FIG. 17A, FIG. 17B, and FIG. 17C are graphs for showing line analysis results of the sectional surface of the sample alloy according to Example 3 with an electron probe microanalyzer, and FIG. 17D is an image for showing line analysis results of the sectional surface of the sample alloy according to Example 3 with an electron probe microanalyzer;

FIG. 18 is a graph for showing an X-ray diffraction profile of the sectional surface of the sample alloy according to Example 3;

FIG. 19 is an image for showing tungsten probes used for measurement of an electrical resistance value;

FIG. 20 is a backscattered electron image of a sectional surface of a sample alloy according to Comparative Example 2 with a scanning electron microscope;

FIG. 21A, FIG. 21B, and FIG. 21C are graphs for showing line analysis results of the sectional surface of the sample alloy according to Comparative Example 2 with an electron probe microanalyzer, and FIG. 21D is an image for showing line analysis results of the sectional surface of the sample alloy according to Comparative Example 2 with an electron probe microanalyzer;

FIG. 22 is a backscattered electron image of a sectional surface of a sample alloy according to Comparative Example 3 with a scanning electron microscope;

FIG. 23A, FIG. 23B, and FIG. 23C are graphs for showing line analysis results of the sectional surface of the sample alloy according to Comparative Example 3 with an electron probe microanalyzer, and FIG. 23D is an image for showing line analysis results of the sectional surface of the sample alloy according to Comparative Example 3 with an electron probe microanalyzer; and

FIG. 24 is a schematic view of a production apparatus to be used for production of an iron-based soft magnetic material according to a third embodiment by continuous casting.

### DETAILED DESCRIPTION OF THE PREFERRED EMBODIMENTS

### First Embodiment

An iron-based soft magnetic material according to a first embodiment includes a parent phase containing iron (Fe) as a main component and a grain boundary phase containing as a main component a sulfide containing copper (Cu).

The parent phase is formed of crystal grains each containing iron as a main component. The parent phase is preferably formed of at least one selected from the group consisting of pure iron (Fe), an iron-silicon (Fe—Si) alloy, an iron-cobalt (Fe—Co) alloy, an iron-aluminum (Fe—Al) alloy, an iron-silicon-aluminum (Fe—Si—Al) alloy, and an iron-nickel (Fe—Ni) alloy. The parent phase may be formed of any combination of these materials.

The grain boundary phase is present in a crystal grain boundary of an iron-based material constituting the parent phase. The main component of the grain boundary phase is a sulfide containing copper (Cu). The sulfide containing copper (grain boundary phase) is desirably formed of at least one selected from the group consisting of Cu₂S, Cu₅FeS₄, and CuFeS₂, and sulfides represented by molecular formulae in which a metal element (iron or copper) is lost from the above-mentioned sulfides (Cu₂S, Cu₅FeS₄, and CuFeS₂). It has been reported that Cu₂S has a specific resistance of 2.3×10³ Ωm, Cu₅FeS₄ has a specific resistance of 1.6 Ωm, and CuFeS₂ has a specific resistance of 150 Ωm. All of those compounds have high electrical resistance values. In addition, a compound in which a metal element (iron or copper) is lost from Cu₂S, Cu₅FeS₄, or CuFeS₂ (e.g. Cu₈S₅ is considered to be a compound in which two copper atoms are lost from five Cu₂S molecules) is considered to have a higher specific resistance. The iron-based soft magnetic material including the grain boundary phase formed of such substance having a high specific resistance has a high electrical resistance. Therefore, the iron-based soft magnetic material achieves a reduction in eddy current loss when an alternating-current magnetic field is applied thereto. It should be noted that the grain boundary phase may contain as its constituent component a trace amount of a component other than the components listed above, for example, a low-resistance component (low-resistance phase) such as Cu or FeS. In this case, the low-resistance component needs to be contained in such a manner as to be prevented from inhibiting the insulating property of the grain boundary phase. For example, it is preferred that the low-resistance component be present in the grain boundary phase so that the low-resistance component is isolated in an island shape without penetrating in the thickness direction of the grain boundary phase, that is, the adjacent parent phases are prevented from being electrically connected to each other through the low-resistance component.

The grain boundary phase only needs to be present in the crystal grain boundary of the parent phase, but ideally, it is preferred that the grain boundary phase form a three-dimensional network structure such as a cell wall along the crystal grain boundary of the parent phase so as to separate the crystal grains of the iron-based material constituting the parent phase from each other. This is because that, when the crystal grains of the parent phase are separated from each other by the grain boundary phase, a reduction in electrical resistance value resulting from electrical connection between the crystal grains of the parent phase can be prevented. In this case, the ratio of the volume of the grain boundary phase (grain boundary phase volume ratio) to the volume of the entire iron-based soft magnetic material (the volume of the parent phase+the volume of the grain boundary phase) is desirably 2 vol % or more and 30 vol % or less. When the grain boundary phase volume ratio is less than 2 vol %, there may be a shortage of the grain boundary phase for separating the crystal grains of the parent phase from each other. In contrast, when the grain boundary phase volume ratio exceeds 30 vol %, the maximum magnetization of the iron-based soft magnetic material may be reduced. Accordingly, it is preferred that the grain boundary phase volume ratio be 2 vol % or more and 30 vol % or less.

When the grain boundary phase volume ratio is from 2 vol % to 30 vol %, the ratio of the volume of the parent phase (parent phase volume ratio) to the volume of the entire iron-based soft magnetic material (the volume of the parent phase+the volume of the grain boundary phase) is 70 vol % or more and 98 vol % or less. The volume ratio is approximately equal to an atomic concentration. Therefore, it is preferred that the content ratio of a constituent component of the parent phase be 70 at % or more and 98 at % or less.

The iron-based soft magnetic material according to the first embodiment is preferably formed by casting. In this case, a method of producing the iron-based soft magnetic material according to the first embodiment desirably includes: a melting step of melting copper, iron, an iron sulfide, and as required a metal constituting the parent phase other than iron (silicon, cobalt, aluminum, or nickel) after being weighed so as to achieve desired content ratios, to form a molten alloy; and a casting step of casting the molten alloy formed through the melting step in a casting mold.

In the melting step, for example, a vacuum induction melting furnace may be used. In this case, raw materials (copper, iron, an iron sulfide, and the like) after being weighed are put in, for example, a crucible made of alumina which is disposed in a chamber, the inside of the chamber is vacuumed, and then a high-frequency current is applied to a coil arranged on the external surface of the crucible to melt the raw materials in the crucible. In order to remove oxygen contained in the molten alloy formed by the melting or oxygen to be mixed into the molten alloy from the furnace or the like during the melting, a metal element susceptible to oxidation such as aluminum or a rare earth metal, or carbon may be melted together with the raw materials.

In the casting step, the molten alloy formed through the melting step is put in a casting mold (for example, a sand mold). The molten alloy is then cooled in the casting mold to be solidified. Thus, the target iron-based soft magnetic material can be cast molded. It should be noted that removal of a burr formed in a cast product, processing, or the like may be performed as required.

When the molten alloy is put in the casting mold and cooled and solidified in the casting step, first, the parent phase containing iron as a main component precipitates as crystal grains. After that, the sulfide phase containing copper precipitates as the grain boundary phase in the grain boundary between the crystal grains of the parent phase. The sulfide phase is formed of Cu₂S or a sulfide containing iron and copper (Cu₅FeS₄, CuFeS₂, or the like). The reason why the sulfide phase precipitates in the crystal grain boundary of the parent phase is presumed as described below. That is, iron has a melting point of 1,538° C., Cu₂S has a melting point of 1,120° C., Cu₅FeS₄ has a melting point of 1,050° C., and CuFeS₂ has a melting point of 950° C. Therefore, iron having the highest melting point first precipitates as a first crystal. After that, in the course of progression of the solidification, the sulfides each having a lower melting point than iron surround the crystal grains of the parent phase in a liquid phase state, and are solidified while maintaining the state in which the sulfides surround the crystal grains. As a result, the sulfide phase precipitates in the crystal grain boundary of the parent phase. The contact between the crystal grains of the parent phase is blocked by virtue of the sulfide phase precipitating in the crystal grain boundary of the parent phase. Therefore, a reduction in electrical resistance value resulting from electrical connection between the crystal grains of the parent phase can be prevented.

The casting step may include: a step of retaining the molten alloy in a temperature range of from 950° C. to 1,500° C. for a predetermined time period (retention step); and a step of cooling a cast body (molten alloy) after the retention step (cooling step). As described above, the compound constituting the grain boundary phase (sulfide phase) has a melting point of 950° C. (CuFeS₂), 1,050° C. (Cu₅FeS₄), or 1,120° C. (Cu₂S), while iron constituting the parent phase has a melting point of 1,538° C. Therefore, when the molten alloy is retained in a temperature range of from 950° C. to 1,500° C. for a predetermined time period, iron constituting the parent phase is solidified to form crystal grains, and on the other hand, the compound constituting the grain boundary phase is present as a liquid phase in the crystal grain boundary. With this, the grain boundary phase containing as a main component the sulfide containing copper can be formed along the crystal grain boundary of the parent phase containing iron as a main component. The retention temperature of the molten alloy in the retention step is preferably a temperature lower than the melting point of iron and higher than the melting point of the sulfide constituting the grain boundary phase.

It should be noted that incorporation of solid solutions of impurities such as sulfur and copper into iron constituting the parent phase causes a reduction in maximum magnetization, an increase in hysteresis loss, and the like. Regarding this point, the amount of a sulfur solid solution in iron is trace (0.25 at %, 0.14 mass % at a maximum), and the amount of a copper solid solution in iron can be reduced to 1 at % (1.14 mass %) by appropriate heat treatment. As just described, in the crystal grains of iron constituting the parent phase, the concentration of sulfur is low, and the concentration of copper can be reduced. Accordingly, in the case of casting the molten alloy containing iron, copper, and sulfur, sulfur and copper are considered to be hardly present in the crystal grains constituting the parent phase which contains iron as a main component.

Next, a preferred combination of the content ratios of iron and a constituent component of the parent phase other than iron (Fe+β), copper, and sulfur is considered in the iron-based soft magnetic material according to the first embodiment. Herein, the “iron and a constituent component of the parent phase other than iron” corresponds to “the constituent component of the parent phase” in the case where iron is not contained in the grain boundary phase, and to “iron in the grain boundary phase and the constituent component of the parent phase” in the case where iron is contained in the grain boundary phase. The constituent component of the parent phase other than iron (β) is, for example, silicon, cobalt, aluminum, nickel, or the like. The component β may not be present. In this case, the parent phase is formed of pure iron.

First, a preferred ratio of the content ratios between copper and sulfur in the grain boundary phase is considered. In the case where the grain boundary phase is formed of Cu₂S, the ratio of the content ratios between copper and sulfur in the grain boundary phase is copper:sulfur=2:1 in terms of atomic concentration. That is, the ratio α(S/Cu), which represents a ratio of the atomic concentration of sulfur to the atomic concentration of copper, is 0.5. In the case where the grain boundary phase is formed of CuFeS₂, the ratio of the content ratios between copper and sulfur in the grain boundary phase is copper:sulfur=1:2 in terms of atomic concentration. That is, the ratio α(S/Cu) is 2.0.

Even when the ratio α(S/Cu) is less than 0.5, Cu₂S can be allowed to precipitate in the grain boundary phase. However, copper precipitates in the grain boundary phase together with Cu₂S owing to copper being excessive with respect to sulfur. When copper precipitates in the grain boundary phase, the electrical resistance value of the iron-based soft magnetic material is significantly reduced owing to copper having a lower specific resistance. Therefore, the ratio α(S/Cu) is preferably 0.5 or more. In addition, when the ratio α(S/Cu) exceeds 2.0, a phase of a compound of iron and sulfur (FeS) precipitates in the grain boundary phase owing to a lack of copper with respect to sulfur for precipitation of CuFeS₂ in the grain boundary phase. When FeS precipitates in a large amount in the grain boundary phase, the electrical resistance value of the iron-based soft magnetic material is reduced because the specific resistance of FeS is not so high. Therefore, the ratio α(S/Cu) is preferably 2.0 or less. Based on the foregoing results, it is preferred that the ratio α(S/Cu) be 0.5 or more and 2.0 or less. That is, the ratio of the contents between copper and sulfur is preferably copper:sulfur=1:2-2:1 in terms of atomic concentration.

It should be noted that, in the case where the sulfide phase is formed of Cu₅FeS₄, the ratio of the content ratios between copper and sulfur is copper:sulfur=5:4 (ratio α(S/Cu)=0.8) in the grain boundary phase in terms of atomic concentration. In this case, Cu₂S or CuFeS₂ may arise in the sulfide phase, but only Cu₅FeS₄ may arise in the sulfide phase.

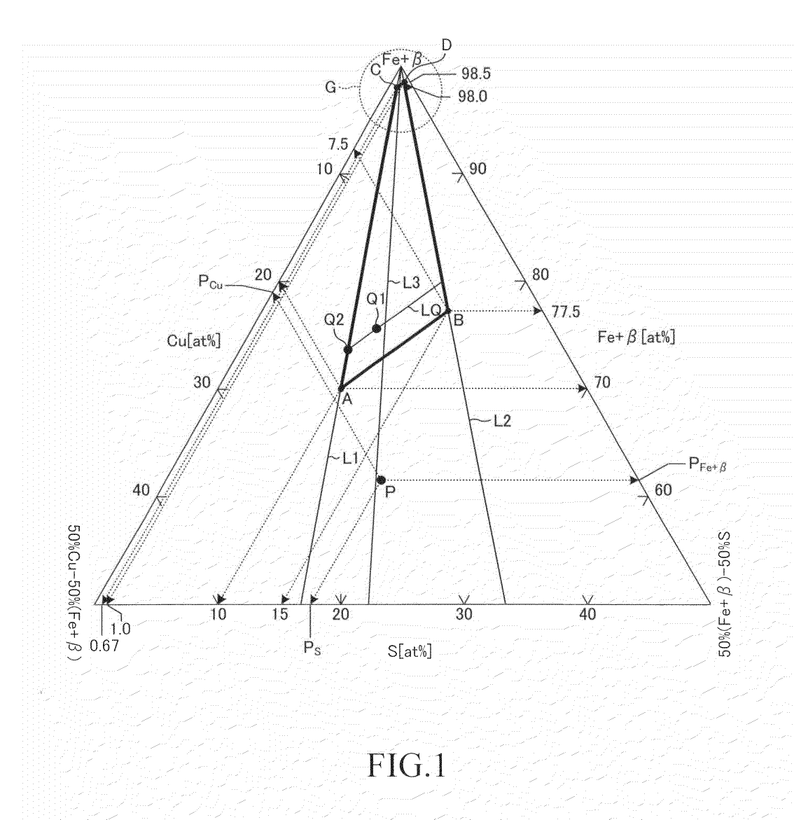

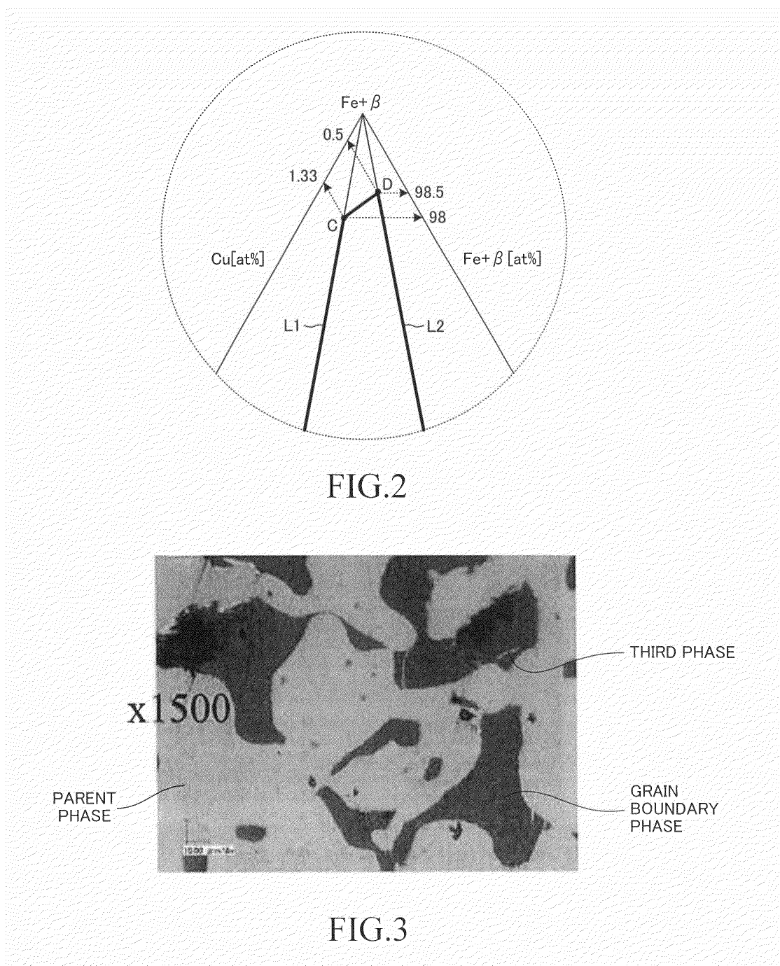

Next, based on the above-mentioned preferred ratio of the content ratios between copper and sulfur in the grain boundary phase (sulfide phase), a preferred combination of the content ratios of iron and the constituent component of the parent phase other than iron (Fe+β), copper (Cu), and sulfur (S) is considered. FIG. 1 is a ternary composition diagram of the atomic concentrations of iron and the constituent component of the parent phase other than iron (Fe+β), copper (Cu), and sulfur (S). A detail view of a portion G of FIG. 1 is illustrated in FIG. 2. The ternary composition diagram illustrated in FIG. 1 simultaneously represents a combination of the content ratios (atomic concentrations [at %]) of Fe+β, Cu, and S. The atomic concentration of Fe+β at an arbitrary point P in FIG. 1 is represented by a point P_{Fe+β} at which the point P intersects with the scale for Fe+β when being moved parallel to the scale (scale axis) for sulfur (S). The atomic concentration of copper (Cu) at the arbitrary point P is represented by a point P_{Cu} at which the point P intersects with the scale for copper (Cu) when being moved parallel to the scale for Fe+β. The atomic concentration of sulfur (S) at the arbitrary point P is represented by a point P_{S} at which the point P intersects with the scale for sulfur (S) when being moved parallel to the scale for copper (Cu). Accordingly, the combination of the atomic concentrations of Fe+β, copper (Cu), and sulfur (S) at the point P is represented as P_{Fe+β} at % (Fe+β)-P_{Cu} at % Cu-P_{S} at % S.

In FIG. 1 and FIG. 2, a point group having a ratio of the atomic concentration of sulfur (S) to the atomic concentration of copper (Cu), α(S/Cu), of 0.5 is represented by a line L1. When the ratio α(S/Cu)=0.5, Cu₂S precipitates in the grain boundary phase, and iron is entirely used as a constituent material of the parent phase. In this case, the atomic concentration of the constituent component of the parent phase is equal to the atomic concentration of iron and the constituent component of the parent phase other than iron (Fe+β). As described above, the atomic concentration of the constituent component of the parent phase is preferably 70 at % or more. The point at which the ratio α(S/Cu)=0.5 and the atomic concentration of the constituent component of the parent phase (that is, the atomic concentration of iron and the constituent component of the parent phase other than iron (Fe+β)) is 70 at % is represented by a point A on the line L1 of FIG. 1. At the point A, the atomic concentration of iron and the constituent component of the parent phase other than iron (Fe+β) is 70 at %, the atomic concentration of copper (Cu) is 20 at %, and the atomic concentration of sulfur (S) is 10 at % (70 at % (Fe+β)-20 at % Cu-10 at % S).

Furthermore, as described above, the atomic concentration of the constituent component of the parent phase is preferably 98 at % or less. The point at which the ratio α(S/Cu)=0.5 and the atomic concentration of the constituent component of the parent phase (that is, the atomic concentration of iron and the constituent component of the parent phase other than iron (Fe+β)) is 98% is represented by a point C on the line L1 of FIG. 1 and FIG. 2. At the point C, the atomic concentration of iron and the constituent component of the parent phase other than iron (Fe+β) is 98 at %, the atomic concentration of copper (Cu) is 1.33 at %, and the atomic concentration of sulfur (S) is 0.67 at % (98 at % (Fe+β)-1.33 at % Cu-0.67 at % S).

In FIG. 1 and FIG. 2, a point group having a ratio of the atomic concentration of sulfur (S) to the atomic concentration of copper (Cu), α(S/Cu), of 2.0 is represented by a line L2. When the ratio α(S/Cu)=2.0, CuFeS₂ precipitates in the grain boundary phase. Therefore, iron is also contained in the grain boundary phase. The ratio of the number of iron atoms to the total number of atoms in the grain boundary phase (CuFeS₂) is 0.25. That is, Fe in the number of atoms of ¼ of the number of atoms in the grain boundary phase is required as Fe constituting the grain boundary phase. When the ratio α(S/Cu)=2.0 and the atomic concentration of the constituent component of the parent phase is 70 at %, the atomic concentration of the constituent component of the grain boundary phase is 30 at %, and hence the atomic concentration of iron constituting the grain boundary phase is 7.5 at % with respect to the entire alloy. Accordingly, an atomic concentration obtained by adding the atomic concentration of iron constituting the grain boundary phase (7.5 at %) to the atomic concentration of the constituent component of the parent phase (70 at %), (77.5 at %), is the atomic concentration of iron and the constituent component of the parent phase other than iron (Fe+β). The alloy composition in which the ratio α(S/Cu)=2.0 and the total atomic concentration of Fe+β in the alloy is 77.5 at % (in this case, the atomic concentration of the constituent component of the parent phase is 70 at %) is represented by a point B on the line L2 of FIG. 1. At the point B, the atomic concentration of Fe+β is 77.5 at %, the atomic concentration of copper (Cu) is 7.5 at %, and the atomic concentration of sulfur (S) is 15 at % (77.5 at % (Fe+β)-7.5 at % Cu-15 at % S).

In the case where the ratio α(S/Cu)=2.0 and the atomic concentration of the constituent component of the parent phase is 98 at %, the atomic concentration of the constituent component of the grain boundary phase is 2 at %, and hence the atomic concentration of iron constituting the grain boundary phase is 0.5 at % with respect to the entire alloy. Therefore, an atomic concentration obtained by adding the atomic concentration of iron constituting the grain boundary phase (0.5 at %) to the atomic concentration of the constituent component of the parent phase (98 at %), (98.5 at %), is the atomic concentration of iron and the constituent component of the parent phase other than iron (Fe+β) The point at which the ratio α(S/Cu)=2.0 and the atomic concentration of Fe+β is 98.5 at % (in this case, the atomic concentration of the constituent component of the parent phase is 98 at %) is represented by a point D on the line L2 of FIG. 1 and FIG. 2. At the point D, the atomic concentration of Fe+β is 98.5 at %, the atomic concentration of copper (Cu) is 0.5 at %, and the atomic concentration of sulfur (S) is 1.0 at % (98.5 at % (Fe+β)-0.5 at % Cu-1.0 at % S).

In view of the foregoing, when the combination of the content ratios (atomic concentrations) of Fe+β, copper (Cu), and sulfur (S) is a combination in a region bounded by the four points in the ternary composition diagram of FIG. 1, the point A (70 at % (Fe+β)-20 at % Cu-10 at % S), the point B (77.5 at % (Fe+β)-7.5 at % Cu-15 at % S), the point C (98 at % (Fe+β)-1.33 at % Cu-0.67 at % S), and the point D (98.5 at % (Fe+β)-0.5 at % Cu-1.0 at % S), the iron-based soft magnetic material in which the grain boundary phase volume ratio is 2 vol % or more and 30 vol % or less (the atomic concentration of the constituent component of the parent phase is 70 at % or more and 98 at % or less) and at least one of Cu₂S, Cu₅FeS₄, or CuFeS₂ precipitates as the grain boundary phase can be formed. That is, a preferred combination of the content ratios (atomic concentrations) of Fe+β, copper (Cu), and sulfur (S) is a combination in a region bounded by the four points in the ternary composition diagram, the point A (70 at % (Fe+β)-20 at % Cu-10 at % S), the point B (77.5 at % (Fe+β)-7.5 at % Cu-15 at % S), the point C (98 at % (Fe+β)-1.33 at % Cu-0.67 at % S), and the point D (98.5 at % (Fe+β)-0.5 at % Cu-1.0 at % S).

It should be noted that, in the case of allowing Cu₅FeS₄ to precipitate in the grain boundary phase, the ratio α(S/Cu) is 0.8. In FIG. 1, a point group having a ratio α(S/Cu)=0.8 is represented by a line L3. The point at which the ratio α(S/Cu)=0.8 and the atomic concentration of iron and the constituent component of the parent phase other than iron Fe+β is 73 at % (in this case, the atomic concentration of the constituent component of the parent phase is 70 at %) lies in the region bounded by the points A, B, C, and D. In addition, the point at which the ratio α(S/Cu)=0.8 and the atomic concentration of iron and the constituent component of the parent phase other than iron Fe+β is 98.2 at % (in this case, the atomic concentration of the constituent component of the parent phase is 98 at %) also lies in the region bounded by the points A, B, C, and D.

In FIG. 1, a line connecting the point A and the point B is parallel to a line connecting the point C and the point D. Now, a line passing through an arbitrary point Q1 in the region bounded by the points A, B, C, and D and parallel to the line connecting the points A and B (or the line connecting the points C and D) is defined as a line LQ. In addition, the point at which the line LQ intersects with the line connecting the point A and the point C is defined as a point Q2. Upon such definitions, the content ratio of the constituent component of the parent phase in an alloy having a composition represented by the point Q1 is desirably equal to the content ratio of the constituent component of the parent phase in an alloy having a composition represented by the point Q2. For example, in the case where the content ratio of the constituent component of the parent phase (in this case, iron and the constituent component of the parent phase other than iron) of the alloy having a composition represented by the point Q2 is 75 at %, it is desired that also the content ratio of the constituent component of the parent phase in the alloy having a composition represented by the point Q1 be 75 at %. That is, alloys having compositions represented by points on a line parallel to the line connecting the points A and B (or the line connecting the points C and D) desirably entirely have the same content ratio of the constituent component of the parent phase.

In addition, it is desired that a component represented by a difference between the content ratio of iron and the constituent component of the parent phase other than iron Fe+β in the alloy having a composition represented by the point Q1 and the content ratio of iron and the constituent component of the parent phase other than iron Fe+β in the alloy having a composition represented by the point Q2 entirely result from iron. That is, it is desired that an increase in content ratio of Fe+β at the point Q1 from the content ratio of Fe+β at the point Q2 entirely result from iron. That is, in the alloys having compositions represented by the points on the line parallel to the line connecting the points A and B (or the line connecting the points C and D), it is desired that a change in Fe+β entirely result from iron constituting the grain boundary phase.

The method of producing the iron-based soft magnetic material according to the first embodiment may further include a heat treatment step of subjecting a cast molded ingot (iron-based soft magnetic material) to heat treatment. In this case, the cast molded ingot is put in, for example, an electric furnace. Next, the temperature of the ingot is increased while an inert gas (for example, argon or nitrogen) is allowed to flow through the electric furnace in order to prevent the surface of the ingot from being oxidized, and the ingot is heated and retained at a predetermined temperature for a predetermined time period. After that, the ingot is cooled. The cooling is selected from rapid cooling to slow cooling depending on demand characteristics. In the case of the rapid cooling, there may be adopted a water cooling method involving putting the ingot in water immediately after taking out the ingot from the electric furnace at high temperature, or an air cooling method involving stopping heating of a heating device in the electric furnace and introducing air or an inert gas at room temperature into the electric furnace. The slow cooling may be performed by, for example, gradually reducing the heating temperature of the heating device in the electric furnace. A higher cooling rate can shorten the time required for the heat treatment, but has a disadvantage of a greater loss owing to larger strain in the inside of the ingot. Therefore, it is appropriate to optimize the cooling rate depending on the production cost and the demand characteristics. In addition, while the inert gas is allowed to flow through the electric furnace in the heat treatment in order to prevent the surface of the ingot from being oxidized, the heat treatment may be performed in the air atmosphere in the case where a demand value for maximum magnetization is low, because the inert gas is allowed to flow aiming at preventing a reduction in maximum magnetization owing to oxidation. Furthermore, the heat treatment may be continuously performed in the casting mold after the casting. Specifically, the ingot may be subjected to heat treatment by, after the casting, maintaining the temperature of the casting mold at a predetermined temperature for a predetermined time period, followed by gradually reducing the temperature of the mold. Through such heat treatment, that is, magnetic annealing, magnetic hysteresis can be reduced in the case of using the formed iron-based soft magnetic material as a magnetic part. As a result, magnetic characteristics can be improved.

### EXAMPLE 1

An iron ingot, a copper ingot, and an iron sulfide ingot were weighed so as to achieve atomic concentrations of iron, copper, and sulfur of 78.8 at % Fe-13.0 at % Cu-8.2 at % S. In this case, the mass ratio between iron, copper, and an iron sulfide was iron:copper:iron sulfide=71.8:15.1:13.1. It should be noted that an alloy including a parent phase formed of pure iron is produced in Example 1. Therefore, the constituent component of the parent phase other than iron β is not present.

Next, the weighed ingots were melted (melting step). In this case, first, the weighed iron ingot and copper ingot, and carbon powder at a mass ratio of 0.2% with respect to iron were loaded into a crucible made of alumina. Next, the crucible having loaded therein those raw materials was placed in an induction coil in a vacuum induction melting furnace. In addition, the weighed iron sulfide ingot was loaded into a material loading device provided in the vacuum induction melting furnace. It should be noted that the carbon powder is added in order to allow oxygen mixed in a molten alloy to be melted in the crucible to react with carbon to generate carbon dioxide. The oxygen concentration in the alloy can be reduced by discharging the generated carbon dioxide from the alloy.

Next, the pressure in the melting furnace was reduced to a vacuum of 1 Pa or less, and alternating-current power was then applied to the induction coil while the vacuuming was continued. With this, the raw materials in the crucible made of alumina were heated and melted. After the melting of the raw materials in the crucible was confirmed, the iron sulfide ingot was added to the molten alloy in the crucible by using the material loading device and melted. After that, the energization to the induction coil was shut off, and the molten alloy melted in the crucible was gradually cooled to be solidified while the vacuuming was continued. That is, the alloy was cast by using the crucible as a casting mold. At this time, an infrared thermometer placed in the melting furnace was used to measure the temperature of the alloy to be solidified. When the temperature of the alloy was reduced to 400° C., the vacuuming was completed, and the air was introduced into the melting furnace. After the temperature of the melting furnace was reduced to about room temperature, the alloy was taken out from the melting furnace.

The alloy after being taken out was cut, and the sectional surface was polished. The polished sectional surface was observed with a metallographical microscope. A micrograph of the polished sectional surface is shown in FIG. 3. As shown in FIG. 3, the precipitation of three phases was confirmed in the polished sectional surface. Specifically, a parent phase formed of crystal grains, a grain boundary phase present in a crystal grain boundary of the parent phase, and a white phase seen in the grain boundary phase (third phase) were observed. In FIG. 3, the parent phase corresponds to a white portion, and the grain boundary phase corresponds to a black portion. SEM-EDS (scanning electron microscope/energy dispersive X-ray analyzer) was used to examine the constituent elements of the phases. As a result, it was found that the parent phase was formed of iron, and the grain boundary phase present in the crystal grain boundary of the parent phase was formed of iron, copper, and sulfur. In addition, it was found that the white phase (third phase) present in the grain boundary phase in a scattered manner was formed of copper.

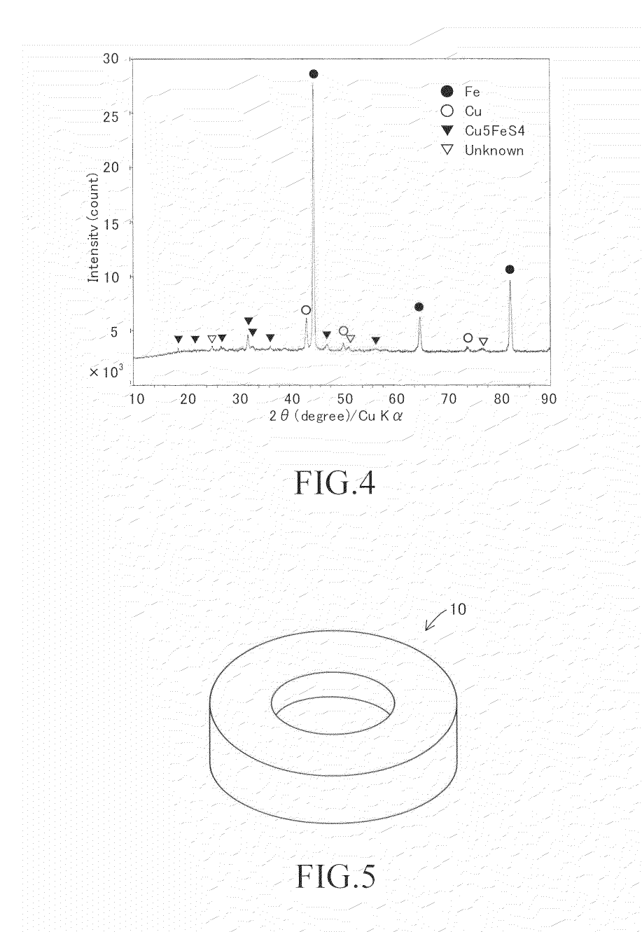

The crystal structure of the alloy was examined with an X-ray diffractometer. A measurement result with an X-ray diffractometer is shown in FIG. 4. From a profile shown in FIG. 4, diffraction peaks that can be determined as a BCC structure having a unit lattice constant a of 0.2868 nm, a FCC structure having a unit lattice constant a of 0.3618 nm, and an orthorhombic crystal having unit lattice constants a, b, and c of 1.086 nm, 2.213 nm, and 1.085 nm, respectively are observed. The respective structures are determined to be iron, copper, and Cu₅FeS₄ (Cu₅FeS₄ has been reported to have a crystal structure of a tetragonal crystal having unit lattice constants a, b, and c of 1.095 nm, 2.190 nm, and 1.095 nm, respectively).

Based on the foregoing results, it can be determined that the parent phase is formed of iron, and in the grain boundary phase, the phase observed as the black portion is formed of Cu₅FeS₄ and the phase observed as the white portion is formed of copper.

Next, the parent phase and the grain boundary phase were each measured for an electrical resistance. The electrical resistance was measured as follows: two probes each made of tungsten with a thin tip were applied onto the phases arising on the polished sectional surface so that the distance between the probes was 20 μm, and the electrical resistance between the probes was measured. As a result, a measurement result in the case of applying the probes onto the parent phase was 12Ω, and a measurement result in the case of applying the probes onto the grain boundary phase (Cu₅FeS₄ phase) was 8.4 kΩ. This revealed that the Cu₅FeS₄ phase serving as the grain boundary phase had an extremely high resistance value. Accordingly, the iron-based soft magnetic material to be produced can exhibit a high electrical resistance when elemental copper precipitates in a small amount and in an isolated manner in the grain boundary phase and majority of the grain boundary phase is formed of the sulfide containing copper.

### Second Embodiment

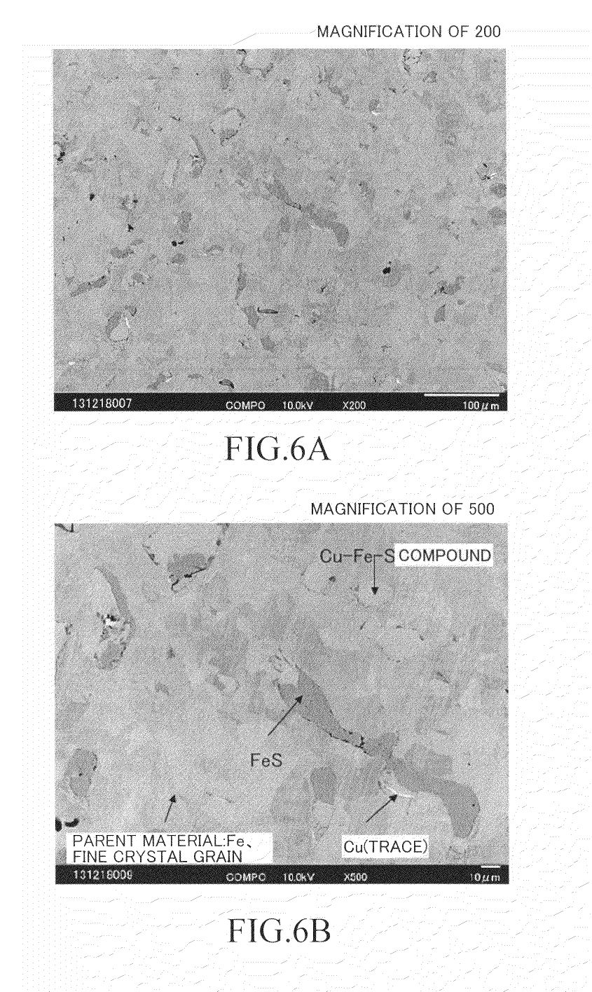

The iron-based soft magnetic material according to Example 1 has a high magnetic permeability and a high electrical resistance. However, when the parent phase is formed of pure iron as in Example 1, the iron-based soft magnetic material has a risk of having low mechanical strength. FIG. 6A and FIG. 6B are scanning electron microscope (SEM) images (FIG. 6A: at a magnification of 200, FIG. 6B: at a magnification of 500) of a polished sectional surface of a cast ingot obtained by melting raw materials that have been weighed so as to achieve a combination of atomic concentrations of iron, copper, and sulfur of 90.8 at % Fe-5.1 at % Cu-4.1 at % S (91.7 wt % Fe-5.9 wt % Cu-2.4 wt % S) by using a vacuum induction melting furnace, followed by solidification. As shown in FIG. 6A and FIG. 6B, a phase formed of copper, iron, and sulfur (Cu—Fe—S compound phase), an iron sulfide (FeS) phase, and copper (Cu) in a trace amount precipitate in the grain boundary. On the other hand, iron in the parent phase is formed of fine polygonal crystal grains. That is, iron in the parent phase is made fine.

The reason why iron in the parent phase is made fine is considered. The iron-based soft magnetic material according to Example 1 is molded by casting the molten alloy containing iron, copper, and sulfur. In the course of cooling after the casting, iron is solidified at the time when the molten alloy is cooled to about 1,538° C. At this time, iron has a crystal structure of a body-centered cubic (BCC) structure (δ phase). When the molten alloy further proceeds with cooling and cooled to about 1,394° C., the crystal structure of iron changes into a face-centered cubic (FCC) structure (γ phase). After that, when the molten alloy still further proceeds with cooling and cooled to about 912° C., the crystal structure changes into a body-centered cubic (BCC) structure (α phase) again.

When the crystal structure changes in the course of the cooling (that is, in the case of phase transition), a discontinuous change in volume occurs. For example, in Journal of the Japan Institute of Metals and Materials, volume 45 (1981) P. 242-249, it has been reported that the volume is reduced by 0.56 vol % with respect to the γ phase through phase transition from the δ phase into the γ phase and that the volume is increased by 0.94 vol % with respect to the α phase through phase transition from the y phase to the α phase. The fine parent phase shown in FIG. 6A and FIG. 6B is considered to be caused by recrystallization of iron constituting the parent phase resulting from strain accumulated through the discontinuous change in volume. Such recrystallization causes cracks in the grain boundary, and hence the mechanical strength of the iron-based soft magnetic material may be reduced.

An iron-based soft magnetic material according to a second embodiment includes a parent phase containing iron as a main component, and a grain boundary phase present in a crystal grain boundary of the parent phase, the grain boundary phase containing as a main component a sulfide containing copper. In addition, the parent phase contains silicon.

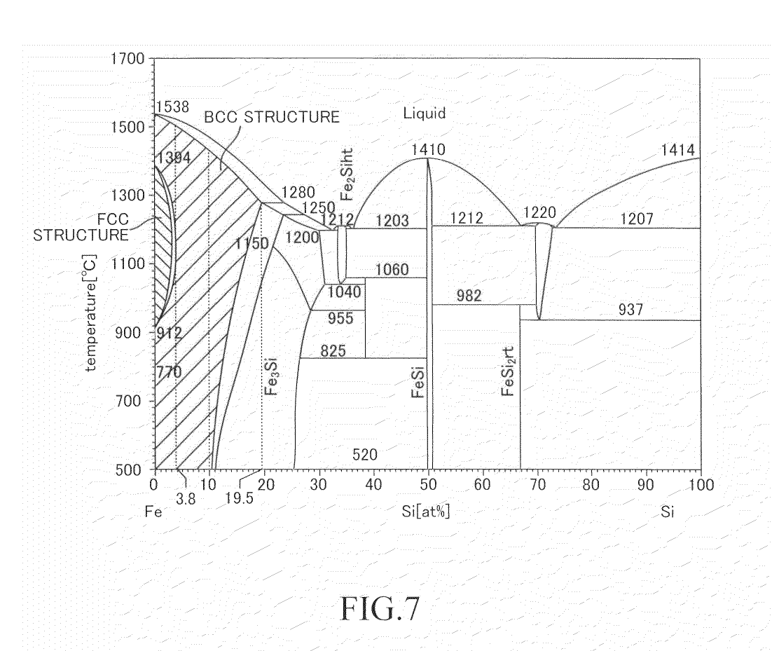

FIG. 7 is an iron (Fe)-silicon (Si)-based equilibrium phase diagram. In FIG. 7, the horizontal axis represents the content ratio [at %] of silicon in iron, and the vertical axis represents temperature [° C.]. As shown in FIG. 7, in the case where the content ratio of silicon is 0 at % or more and less than 3.8 at %, the crystal structure of iron changes from a BCC structure to a FCC structure and further changes from the FCC structure to the BCC structure in the course of cooling of iron or an iron-silicon alloy from a liquid phase. Accordingly, in the case of cooling iron in a liquid form containing less than 3.8 at % of silicon, recrystallization occurs owing to changes in volume due to changes in crystal structure. That is, iron in the parent phase is made fine. In contrast, in the case where the content ratio of silicon is 3.8 at % or more and 10 at % or less, the crystal structure of iron is constantly a BCC structure in the course of cooling of the iron-silicon alloy from a liquid phase. That is, the crystal structure of iron does not change in the course of the cooling. Further, even in the case where the content ratio of silicon is 10 at % or more and 19.5 at % or less, the crystal structure of iron does not change in the course of cooling of the iron-silicon alloy from a liquid phase. It should be noted that, in the case where the content ratio of silicon is 10 at % or more and 19.5 at % or less, an alloy containing a silicon solid solution in iron can be obtained and Fe₃Si can be prevented from precipitating by slowly cooling (gradually cooling) the iron-silicon alloy from a liquid phase. When the content ratio of silicon exceeds 19.5 at %, there is a risk in that Fe₃Si precipitates in the course of the solidification. Fe₃Si has a low specific resistance. Accordingly, when Fe₃Si precipitates in the grain boundary phase, the electrical resistance of the iron-based soft magnetic material is reduced. Therefore, the content ratio of silicon is desirably 19.5 at % or less.

In view of the foregoing, in the case of cast molding the iron-based soft magnetic material, when iron constituting the parent phase in the iron-based soft magnetic material contains 3.8 at % or more and 19.5 at % or less (preferably 3.8 at % or more and 10 at % or less) of silicon, the iron-based soft magnetic material can be cooled to be solidified in the course of the cooling without allowing Fe₃Si having a low specific resistance to precipitate and changing the crystal structure of iron serving as the main component of the parent phase. With this, the parent phase can be prevented from being made fine, and accompanying cracks in the grain boundary phase can be prevented. As a result, the mechanical strength of the iron-based soft magnetic material can be increased.

The main component of the grain boundary phase is a sulfide containing copper (Cu) also in the second embodiment. The sulfide containing copper (the main component of the grain boundary phase) is preferably at least one selected from the group consisting of Cu₂S, Cu₅FeS₄, and CuFeS₂, and sulfides represented by molecular formulae in which a metal element (Fe or Cu) is lost from Cu₂S, Cu₅FeS₄, and CuFeS₂. In addition, the content ratio of the constituent component of the parent phase, that is, the sum total of the content ratio of iron constituting the parent phase (Fe) and the content ratio of silicon (Si) constituting the parent phase is desirably 70 at % or more and 98 at % or less.

The iron-based soft magnetic material according to the second embodiment is produced by casting as with the iron-based soft magnetic material according to the first embodiment. A specific production method is basically the same as the method described in the first embodiment except that the molten alloy contains a desired amount of silicon. A description thereof is omitted.

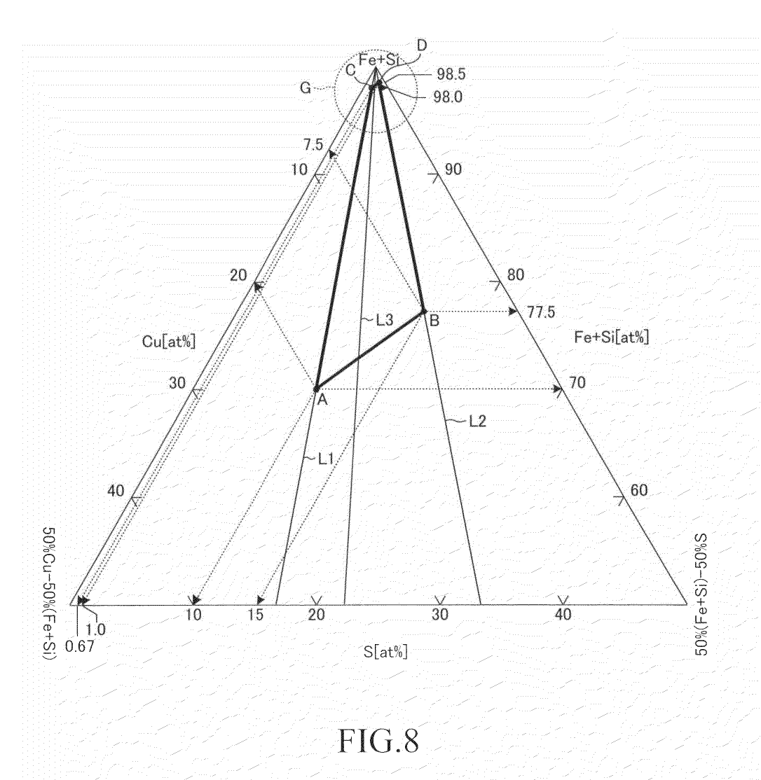

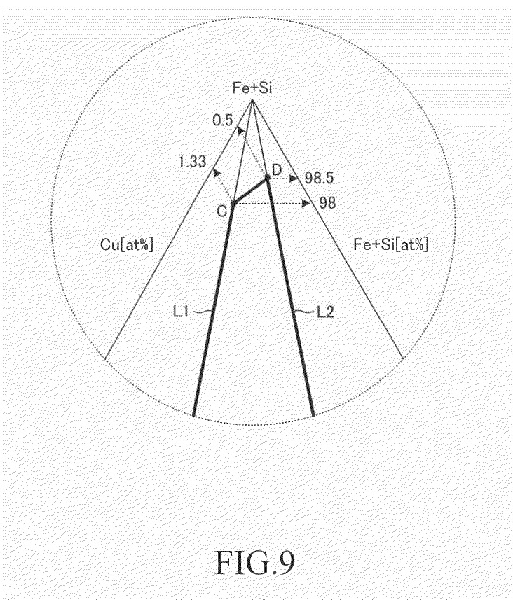

In the second embodiment, the content ratio of iron and silicon is the content ratio of iron and the constituent component of the parent phase other than iron (silicon). Accordingly, a preferred combination of the content ratios of iron+silicon, copper, and sulfur is the same as the preferred combination of the content ratios of iron and the constituent component of the parent phase other than iron (Fe+β), copper (Cu), and sulfur (S) described in the first embodiment. That is, the preferred combination of content ratios of iron and silicon (Fe+Si), copper (Cu), and sulfur (S) is a combination in a region bounded by a point representing 70 at % (Fe+Si)-20 at % Cu-10 at % S, a point representing 77.5 at % (Fe+Si)-7.5 at % Cu-15 at % S, a point representing 98 at % (Fe+Si)-1.33 at % Cu-0.67 at % S, and a point representing 98.5 at % (Fe+Si)-0.5 at % Cu-1.0 at % S in a ternary composition diagram of the atomic concentrations of iron and silicon (Fe+Si), copper (Cu), and sulfur (S). A ternary composition diagram of the atomic concentrations of iron and silicon (Fe+Si), copper (Cu), and sulfur (S) is illustrated in FIG. 8, and a detail view of a portion G of FIG. 8 is illustrated in FIG. 9. A region bounded by points A, B, C, and D in the ternary composition diagram of FIG. 8 is a region representing a preferred combination of the content ratios of iron and silicon, copper, and sulfur.

In addition, also in FIG. 8, it is desired that alloys having compositions represented by points on a line parallel to a line connecting the points A and B (or a line connecting the points C and D) entirely have the same content ratio of the constituent component of the parent phase, as in FIG. 1. Further, in the alloys having compositions represented by the points on the line parallel to the line connecting the points A and B (or the line connecting the points C and D), a change in iron and silicon (Fe+Si) entirely results from iron constituting the grain boundary phase.

### EXAMPLE 2

An iron ingot, a copper ingot, an iron sulfide ingot, and a silicon ingot were weighed so as to achieve atomic concentrations of iron, copper, sulfur, and silicon shown in each of Examples 2-1, 2-2, 2-3, and 2-4 and Comparative Example 1 in Table 1, and melted by the same method as in Example 1. After that, the molten alloy was gradually cooled to be solidified by the same manner as in Example 1. After being cooled to about room temperature, the alloy was taken out from the melting furnace.

TABLE 1

| | Fe | Cu | S | Si |
|---|---|---|---|---|
| Example 2-1 | 80.5 at % | 4.8 at % | 3.7 at % | 11.0 at % |
| | (86.0 wt %) | (5.8 wt %) | (2.3 wt %) | (5.9 wt %) |
| Example 2-2 | 75.2 at % | 4.6 at % | 3.8 at % | 16.4 at % |
| | (82.7 wt %) | (5.8 wt %) | (2.4 wt %) | (9.1 wt %) |
| Example 2-3 | 69.2 at % | 9.7 at % | 10.2 at % | 10.9 at % |
| | (75.6 wt %) | (12.0 wt %) | (6.4 wt %) | (6.0 wt %) |
| Example 2-4 | 83.5 at % | 4.9 at % | 3.8 at % | 7.8 at % |
| | (87.7 wt %) | (5.9 wt %) | (2.3 wt %) | (4.1 wt %) |
| Comparative | 70.5 at % | 4.5 at % | 3.4 at % | 21.6 at % |
| Example 1 | (79.7 wt %) | (5.8 wt %) | (2.2 wt %) | (12.3 wt %) |

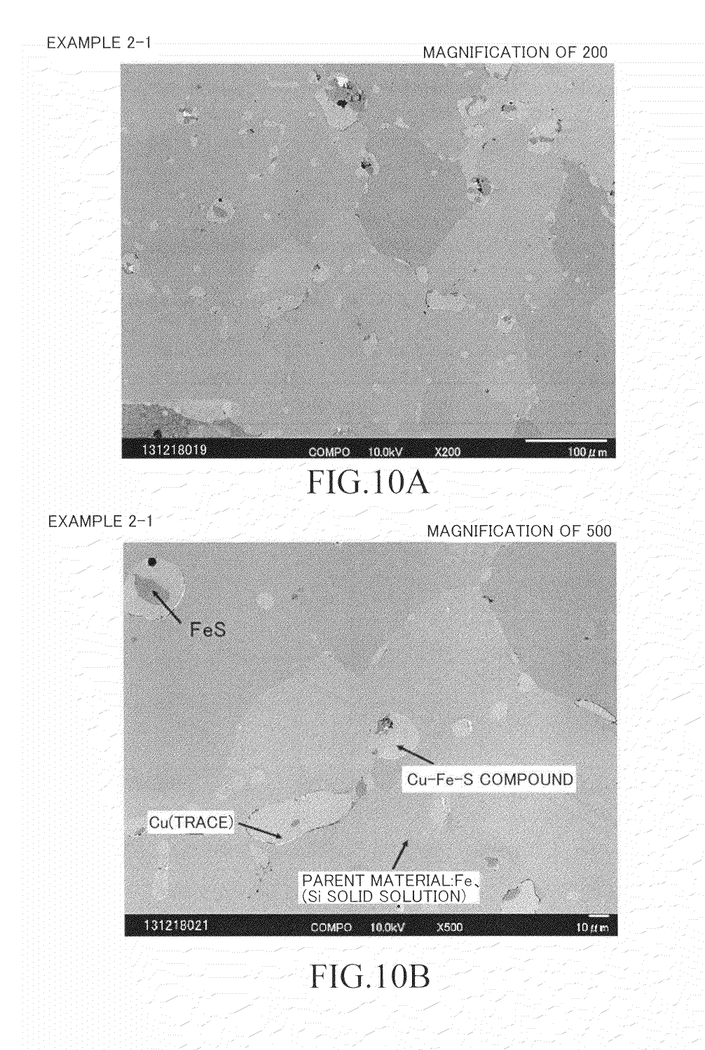

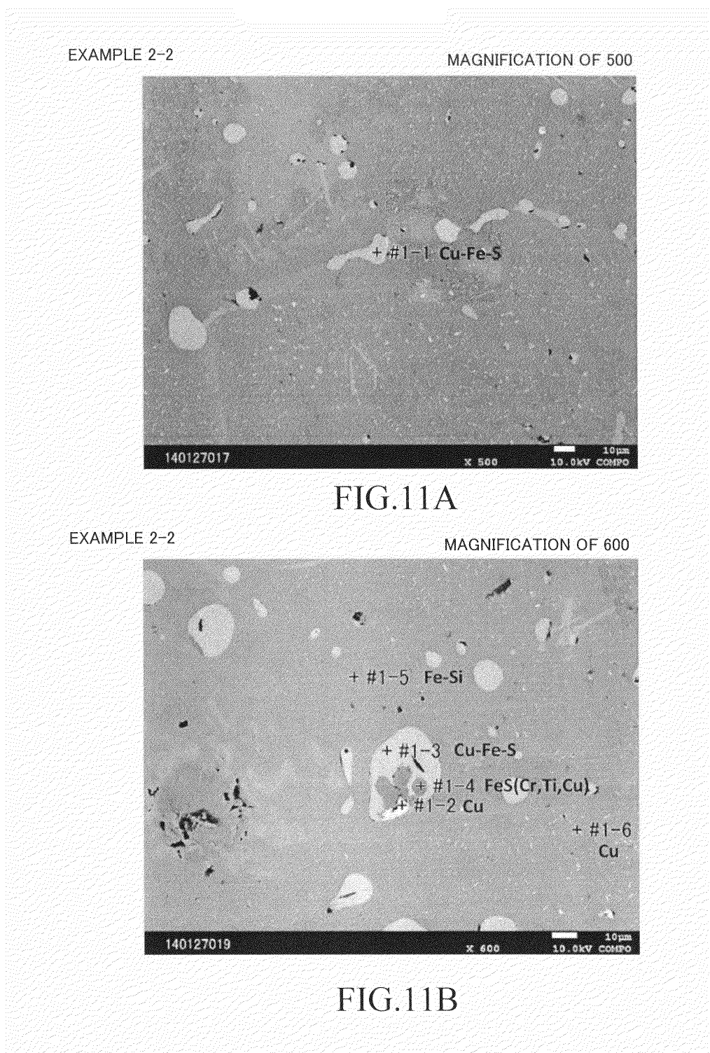

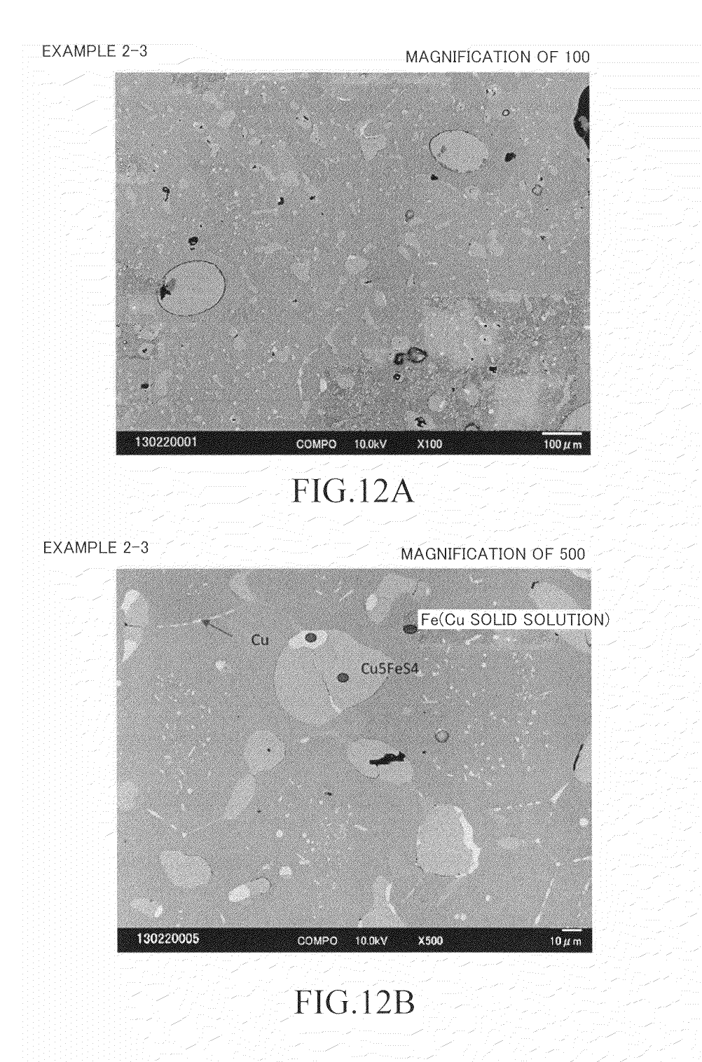

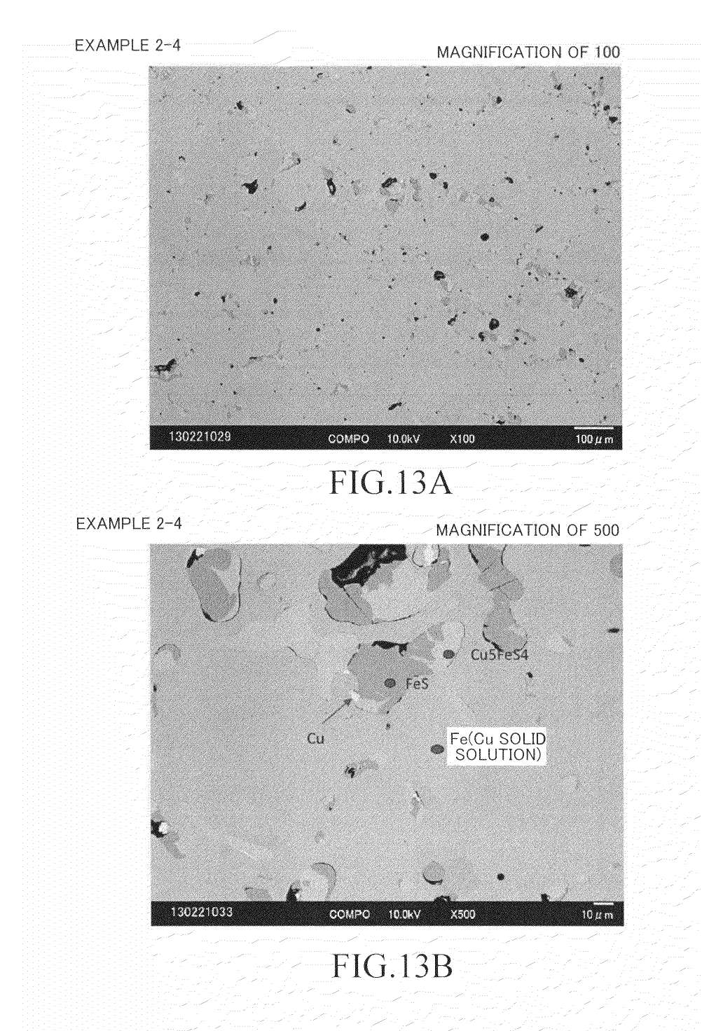

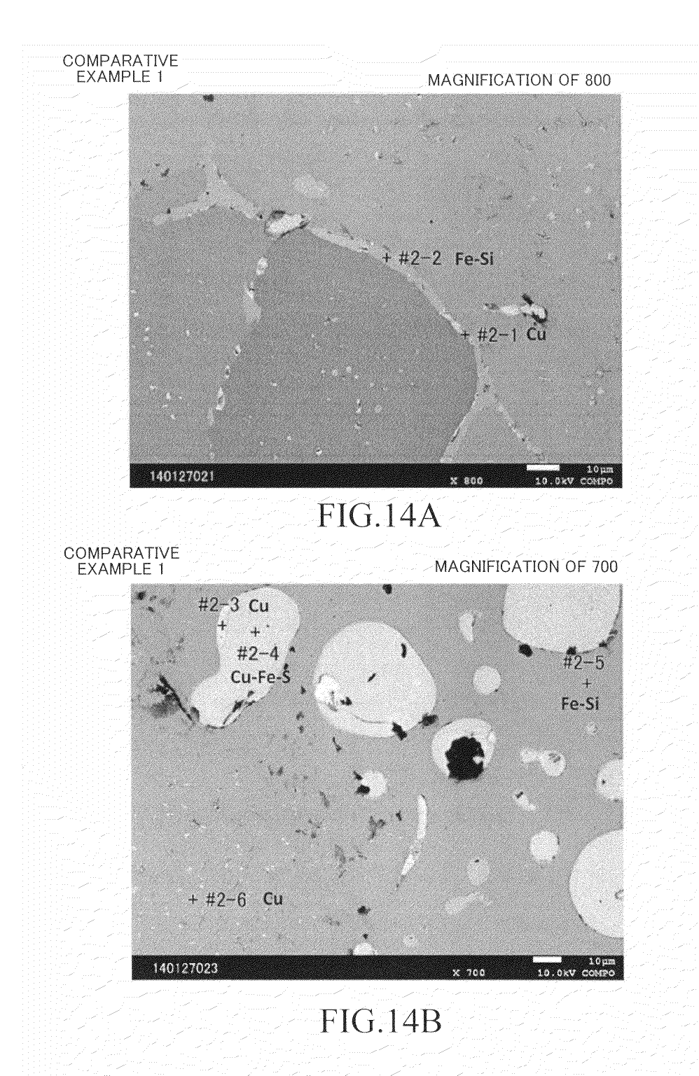

The alloy after being taken out was cut, and the sectional surface was polished. The polished sectional surface was observed with a metallographical microscope. Micrographs of the polished sectional surface of the alloy having a composition shown in Example 2-1 in Table 1 are shown in FIG. 10A and FIG. 10B (FIG. 10A: at a magnification of 200, FIG. 10B: at a magnification of 500). Micrographs of the polished sectional surface of the alloy having a composition shown in Example 2-2 in Table 1 are shown in FIG. 11A and FIG. 11B (FIG. 11A: at a magnification of 500, FIG. 11B: at a magnification of 600). Micrographs of the polished sectional surface of the alloy having a composition shown in Example 2-3 are shown in FIG. 12A and FIG. 12B (FIG. 12A: at a magnification of 100, FIG. 12B: at a magnification of 500). Micrographs of the polished sectional surface of the alloy having a composition shown in Example 2-4 are shown in FIG. 13A and FIG. 13B (FIG. 13A: at a magnification of 100, FIG. 13B: at a magnification of 500). Micrographs of the polished sectional surface of the alloy having a composition shown in Comparative Example 1 are shown in FIG. 14A and FIG. 14B (FIG. 14A: at a magnification of 800, FIG. 14B: at a magnification of 700). Component analysis results with a SEM-EDX are also shown in the micrographs.

As shown in FIG. 10A, FIG. 10B, FIG. 11A, FIG. 11B, FIG. 12A, FIG. 12B, FIG. 13A, FIG. 13B, FIG. 14A, and FIG. 14B, iron constituting the parent phase is found to be not made fine in all examples. Therefore, when the alloy containing iron as a main component contains silicon, the parent phase can be prevented from being made fine, and accompanying cracks in the grain boundary phase can be prevented. As a result, the mechanical strength of the iron-based soft magnetic material can be increased.

In addition, as shown in FIG. 10A and FIG. 10B, silicon is not detected in the grain boundary of the alloy having a composition shown in Example 2-1, and mainly a Cu—Fe—S compound precipitates in the grain boundary. The Cu—Fe—S compound is presumed to be Cu₅FeS₄. Similarly, as shown in FIG. 11A and FIG. 11B, a Cu—Fe—S compound (Cu₅FeS₄) precipitates in the grain boundary of the alloy having a composition shown in Example 2-2. It is considered that the specific resistance (electrical resistivity) of the grain boundary phase is increased by the Cu₅FeS₄ phase.

In addition, as shown in FIG. 12A and FIG. 12B, while copper precipitates in part of the grain boundary of the alloy having a composition shown in Example 2-3, the constituent component of the grain boundary is substantially Cu₅FeS₄. Accordingly, it is considered that the specific resistance (electrical resistivity) of the grain boundary phase can be increased by allowing Cu₅FeS₄ to precipitate in a film form (that is, continuously) so as to surround copper precipitating in the grain boundary. In addition, as shown in FIG. 13A and FIG. 13B, Cu₅FeS₄, FeS, and Cu in a trace amount precipitate in the grain boundary of the alloy having a composition shown in Example 2-4. It is considered that the electrical resistivity of the grain boundary phase can be increased by allowing Cu precipitating in a trace amount to be present in a scattered manner.

In addition, as shown in FIG. 10A, FIG. 10B, FIG. 11A, FIG. 11B, FIG. 12A, FIG. 12B, FIG. 13A, and FIG. 13B, silicon does not precipitate in the grain boundaries of the alloys according to Examples 2-1, 2-2, 2-3, and 2-4. In contrast, as shown in FIG. 14A and FIG. 14B, silicon precipitates in the grain boundary of the alloy according to Comparative Example 1. Based on SEM-EDX analysis, silicon precipitating in the grain boundary of the alloy according to Comparative Example 1 forms a compound with iron and the atomic concentration of silicon is 16 at %. Therefore, the silicon compound precipitating in the grain boundary can be determined as Fe₃Si. When Fe₃Si precipitates in the grain boundary phase, the specific resistance (electrical resistivity) of the alloy is reduced owing to a low specific resistance (electrical resistivity) of Fe₃Si. From the foregoing results, it is revealed that, in the case where the content ratio of Si is too high (more than 19.5 at %), the specific resistance (electrical resistivity) cannot be increased owing to silicon precipitating in the grain boundary phase to form a compound with iron.

### Third Embodiment

An iron-based soft magnetic material according to a third embodiment is produced by melting a raw material for the parent phase containing iron as a main component and a raw material for the grain boundary phase containing as a main component the sulfide containing copper by heating, and then rapidly cooling the melted raw materials at a cooling rate of 10° C./sec or more. That is, a method of producing the iron-based soft magnetic material according to the third embodiment includes: a melting step of melting the raw material for the parent phase containing iron as a main component and the raw material for the grain boundary phase containing as a main component the sulfide containing copper by heating; and a rapid cooling step of rapidly cooling the melted raw materials at a cooling rate of 10° C./sec or more. Herein, the cooling rate in the rapid cooling step is an average cooling rate up to completion of the solidification of the raw materials through the rapid cooling step.

Through the rapid cooling and solidification of the melted raw materials, the grain boundary phase forms a uniform single phase. For example, the grain boundary phase is formed only of a copper sulfide phase having a high resistance value, such as Cu₅FeS₄. With this, the iron-based soft magnetic material to be obtained can exhibit a more increased electrical resistance value. In this case, the grain boundary phase is preferably formed of at least one selected from the group consisting of Cu₂S, Cu₅FeS₄, and CuFeS₂, and sulfides represented by molecular formulae in which a metal element (iron or copper) is lost from Cu₂S, Cu₅FeS₄, and CuFeS₂.

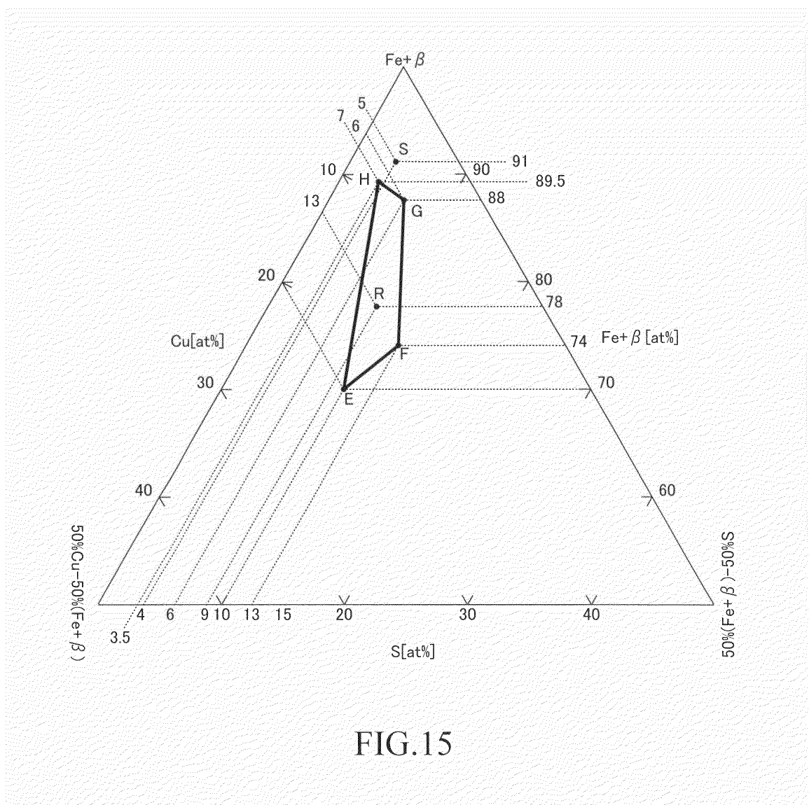

FIG. 15 is a ternary composition diagram of the atomic concentrations of iron and a constituent component of the parent phase other than iron (Fe+β), copper (Cu), and sulfur (S). In the case where the iron-based soft magnetic material is produced by rapidly cooling and solidifying the melted raw materials, a combination of the content ratios (atomic concentrations) of Fe+β, copper (Cu), and sulfur (S) is desirably a combination in a region bounded by points E, F, G, and H in the ternary composition diagram of FIG. 15. Herein, the ternary composition represented by the point E is 70 at % (Fe+β)-20 at % Cu-10 at % S. The ternary composition represented by the point F is 74 at % (Fe+β)-13 at % Cu-13 at % S. The ternary composition represented by the point G is 88 at % (Fe+β)-6 at % Cu-6 at % S. The ternary composition represented by the point H is 89.5 at % (Fe+β)-7 at % Cu-3.5 at % S.

That is, in the case where the iron-based soft magnetic material is produced by rapidly cooling and solidifying the melted raw materials, a combination of the content ratios of iron and the constituent component of the parent phase other than iron (Fe+β), copper (Cu), and sulfur (S) is desirably a combination in a region bounded by the point E representing 70 at % (Fe+β)-20 at % Cu-10 at % S, the point F representing 74 at % (Fe+β)-13 at % Cu-13 at % S, the point G representing 88 at % (Fe+β)-6 at % Cu-6 at % S, and the point H representing 89.5 at % (Fe+β)-7 at % Cu-3.5 at % S in the ternary composition diagram of the atomic concentrations of iron and the constituent component of the parent phase other than iron (Fe+β), copper (Cu), and sulfur (S).

In the case where a composition having a higher concentration of iron (Fe) than ones on a line GH of FIG. 15 is rapidly cooled and solidified, a FeS phase having a low resistance is crystallized out in the grain boundary phase. In addition, also in the case where a composition having a higher concentration of sulfur (S) than ones on a line FG is rapidly cooled and solidified, the FeS phase having a low resistance is crystallized out in the grain boundary phase. In the case where a composition having a higher concentration of copper (Cu) than ones on a line EH is rapidly cooled and solidified, a copper solid solution having a low resistance is crystallized out in the grain boundary phase. In addition, in the case where a composition having a lower concentration of iron (Fe) than ones on a line EF is rapidly cooled and solidified, the ratio of the grain boundary phase is increased, resulting in a reduction in maximum magnetization.

In contrast, in the case where a composition in a region bounded by the points E, F, G, and H in FIG. 15 is rapidly cooled and solidified, the grain boundary phase forms a uniform single phase formed of the sulfide containing copper through the rapid cooling, and hence copper (Cu) and FeS are prevented from being crystallized out in the grain boundary phase. Therefore, for example, the grain boundary phase can be allowed to form a single phase formed of a copper sulfide having a high resistance value, such as Cu₅FeS₄. As a result, the iron-based soft magnetic material to be obtained can exhibit a more increased electrical resistance value. In addition, a sufficient amount of iron is present in the parent phase. Therefore, the maximum magnetization can be increased.

In a case where the temperature of the melted raw materials at the time when the rapid cooling of those raw materials is started exceeds 1,400° C., that is, a rapid cooling start temperature exceeds 1,400° C., the content of iron is increased in the grain boundary phase, and hence FeS precipitates in the grain boundary phase, resulting in a reduction in specific resistance of the grain boundary phase. Besides, the volume fraction of the grain boundary phase is increased, resulting in a reduction in maximum magnetization of the iron-based soft magnetic material. For the above-mentioned reasons, the rapid cooling start temperature is preferably 1,400° C. or less. In addition, in a case where the rapid cooling start temperature is less than 1,000° C., the solidification of the grain boundary phase is completed before the start of the rapid cooling. Accordingly, the grain boundary phase shrinks by its own surface tension to be formed into a spherical shape in the course of the solidification before the rapid cooling. Therefore, even if the rapid cooling is performed thereafter, the grain boundary phase cannot form such a structure as to surround the parent phase owing to its spherical shape. Further, in the course of the solidification before the rapid cooling, a liquid phase constituting the grain boundary phase is separated into two phases. FeS and Cu are crystallized out from the respective structures of the liquid phases separated into two phases. As a result, FeS or Cu is present in the grain boundary phase, resulting in a reduction in specific resistance of the grain boundary phase. For the above-mentioned reasons, the rapid cooling start temperature is preferably 1,000° C. or more. Accordingly, it is desired that the rapid cooling start temperature be 1,000° C. or more and 1,400° C. or less.

In the third embodiment, the melting step is performed by the same method as the method described in the first embodiment. In the rapid cooling step, for example, a vertical tubular furnace having formed in its inside: a first space for hanging the melted raw materials; and a second space formed beneath the first space is used. The vertical tubular furnace includes a shutter for partitioning the first space and the second space. A container filled with water is placed in the second space.

When cooling the melted raw materials using the vertical tubular furnace, first, a sample tube having loaded therein the raw materials melted in the melting step is hung in the first space of the vertical tubular furnace by using a metal wire. After that, the shutter is closed and argon is supplied to the first space. In addition, the raw materials are heated in order to prevent oxidation of the raw materials. The raw materials are then adjusted to a predetermined temperature, followed by opening of the shutter and cutting of the metal wire. With this, the sample tube falls into the container in the second space. The raw materials in the sample tube are rapidly cooled with water filled in the container.

### EXAMPLE 3

An iron ingot, a copper ingot, and an iron sulfide ingot were weighed so as to achieve atomic concentrations of iron, copper, and sulfur of 78 at % Fe-13.0 at % Cu-9 at % S. The ternary composition according to Example 3 is represented by a point R in the ternary composition diagram of FIG. 15. The point R is located in the region bounded by the points E, F, G, and H. It should be noted that an alloy including a parent phase formed of pure iron is produced in Example 3. Accordingly, the constituent component of the parent phase other than iron β is not present.

Next, the weighed ingots were melted by the same method as in Example 1 (melting step). After that, the melted raw materials were put in a sample tube, and the sample tube was hung in the first space of the vertical tubular furnace by using a metal wire. At this time, the first space had a temperature of about 1,500° C. After the sample tube was hung in the first space, the temperature of the first space was adjusted so that the temperature of the raw materials in the sample tube was reduced to 1,365° C. After that, the shutter provided in the vertical tubular furnace was opened, and the metal wire was cut. With this, the sample tube fell into the container in the second space. The raw materials in the sample tube were cooled with water in the container, which is filled with water at normal temperature. In this manner, the melted raw materials were rapidly cooled (rapid cooling step). Through the above-mentioned melting step and rapid cooling step, a sample alloy S1 of an iron-based soft magnetic material according to Example 3 was produced. In Example 3, the rapid cooling start temperature is 1,365° C. In this case, of raw material components, iron is solidified but other components are not solidified before the rapid cooling step. That is, in Example 3, the raw materials in a semi-solidified state are rapidly cooled.

### COMPARATIVE EXAMPLE 2

Raw materials were weighed so as to achieve the same composition as that of the sample alloy S1 according to Example 3, and the weighed raw materials were melted by the same method as in Example 3. After that, the melted raw materials were rapidly cooled by the same method as in Example 3. Through the above-mentioned melting step and rapid cooling step, a sample alloy S2 of an iron-based soft magnetic material according to Comparative Example 2 was produced. In Comparative Example 2, the rapid cooling start temperature is 988° C.

### COMPARATIVE EXAMPLE 3

An iron ingot, a copper ingot, and an iron sulfide ingot were weighed so as to achieve atomic concentrations of iron, copper, and sulfur of 91 at % Fe-5 at % Cu-4 at % S. The ternary composition according to Comparative Example 3 is represented by a point S in the ternary composition diagram of FIG. 15. The point S is located outside the region bounded by the points E, F, G, and H. The weighed ingots were melted by the same method as in Example 1. After that, the melted raw materials were rapidly cooled by the same method as in Example 3. Through the above-mentioned melting step and rapid cooling step, a sample alloy S3 of an iron-based soft magnetic material according to Comparative Example 3 was produced. In Comparative Example 3, the rapid cooling start temperature is 1,365° C., which is the same as in Example 3.

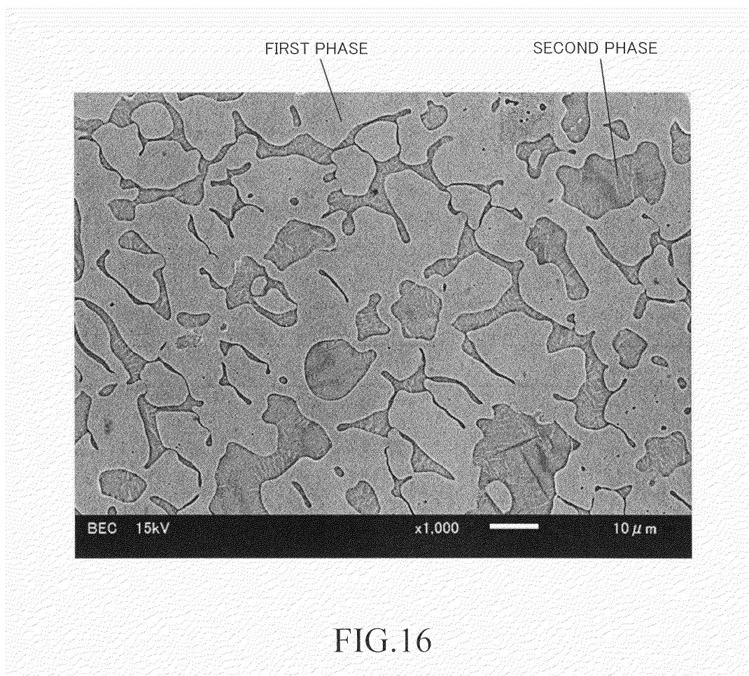

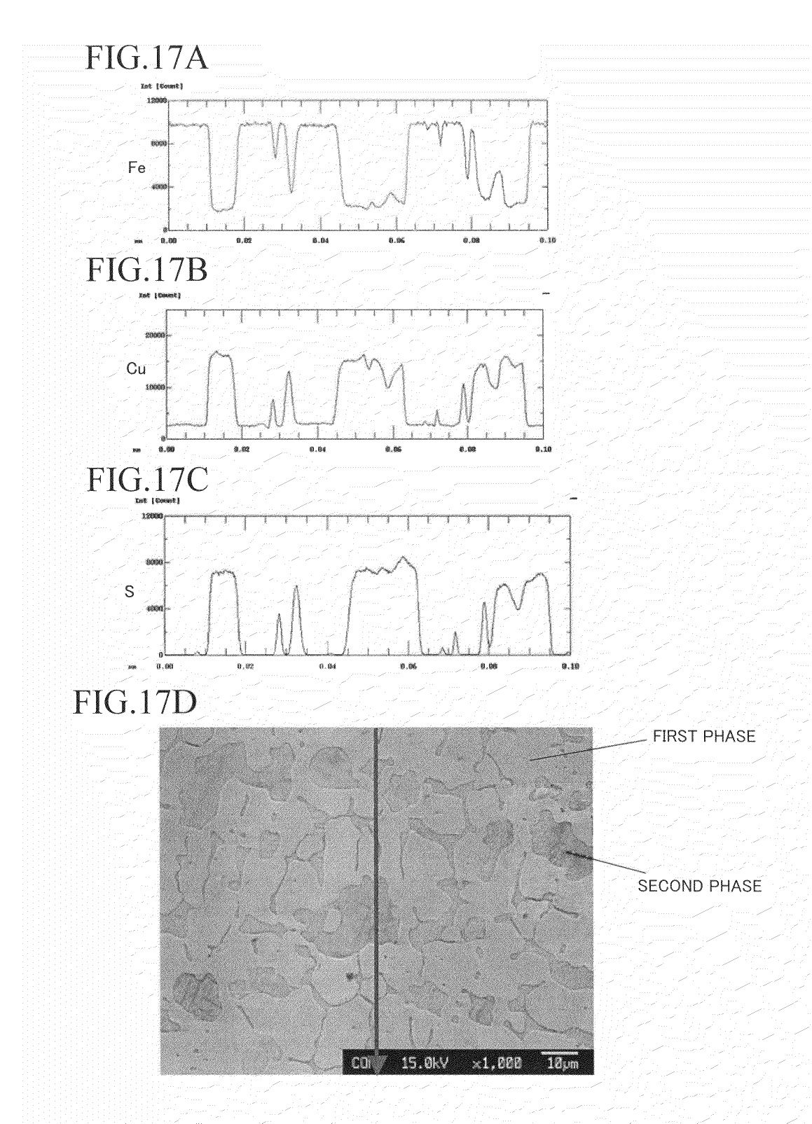

FIG. 16 is a backscattered electron image (BSE image) of a sectional surface of the sample alloy S1 according to Example 3 with a scanning electron microscope (SEM). As shown in FIG. 16, two phases (a first phase and a second phase) are observed in the sectional surface of the sample alloy S1. FIG. 17A, FIG. 17B, and FIG. 17C are line analysis results of the sectional surface of the sample alloy S1 with an electron probe microanalyzer (EPMA). FIG. 17A is a line analysis result of iron (Fe), FIG. 17B is a line analysis result of copper (Cu), and FIG. 17C is a line analysis result of sulfur (S). It should be noted that FIG. 17D is an image for showing the sectional surface of the sample alloy S1 used for obtaining the line analysis results shown in FIG. 17A, FIG. 17B, and FIG. 17C together with a scanning line. As shown in FIG. 17A, FIG. 17B, and FIG. 17C, a region in which mainly iron (Fe) is detected and a region in which mainly copper (Cu) and sulfur (S) are detected are present in the sectional surface of the sample alloy S1.

The region in which mainly iron (Fe) is detected corresponds to a region corresponding to the first phase, and the region in which mainly copper (Cu) and sulfur (S) are detected corresponds to a region corresponding to the second phase. Accordingly, it is revealed that the first phase formed of crystal grains of iron and the second phase containing as a main component the sulfide containing copper are present in the sample alloy S1 according to Example 3. The crystal grains of iron form the parent phase. In addition, an elongated portion is present in the second phase. Accordingly, the second phase is considered to be present in the grain boundary between the crystal grains of iron constituting the parent phase. Therefore, the second phase containing as a main component the sulfide containing copper forms the grain boundary phase. The second phase constituting the grain boundary phase is considered to be formed so as to surround the crystal grains of iron constituting the parent phase by being elongated along the crystal grain boundary.

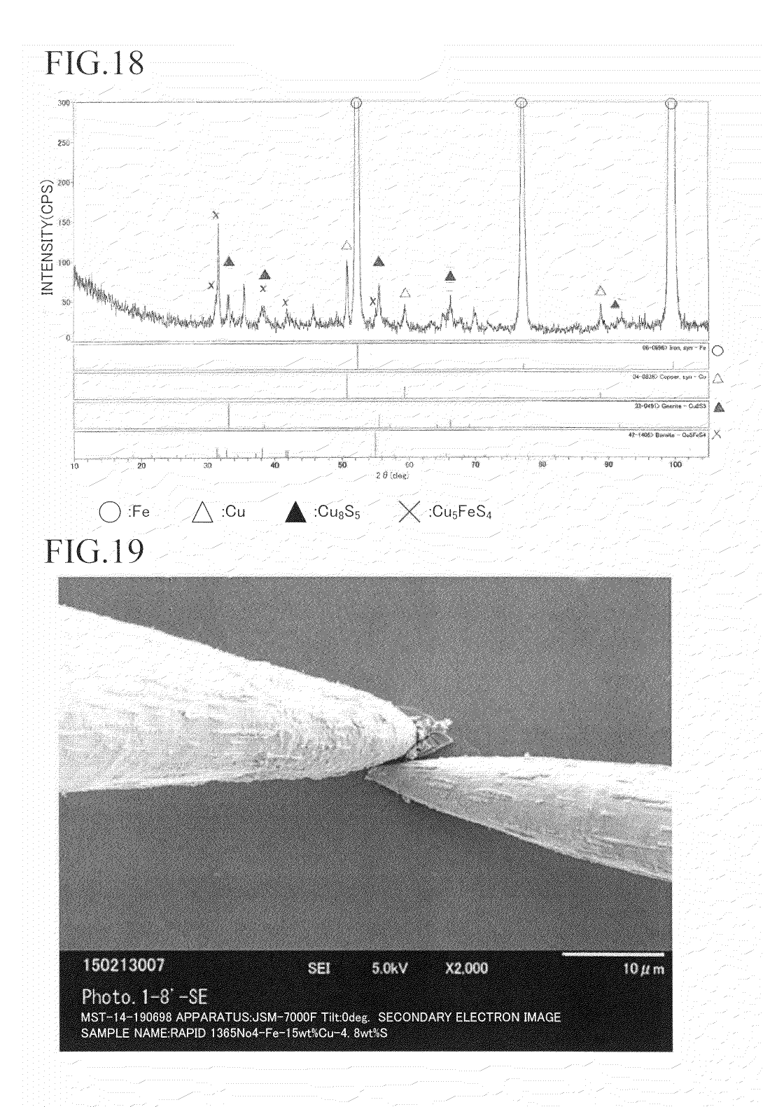

FIG. 18 is an X-ray (Co—Kα line) diffraction profile of the sectional surface of the sample alloy S1 according to Example 3. From FIG. 18, diffraction lines of iron of a body-centered cubic lattice (BCC) structure, copper, Cu₈S₅, and Cu₅FeS₄ were confirmed. In addition, from the line analysis results shown in FIG. 17A, FIG. 17B, and FIG. 17C, it is revealed that copper, sulfur, and a trace amount of iron are present in the grain boundary phase of the sample alloy S1 and the main component of the crystal grains constituting the parent phase is iron. From the foregoing results, it can be said that the sample alloy S1 according to Example 3 has a composition including the parent phase containing as a main component iron of a BCC structure and the grain boundary phase formed of Cu₅FeS₄. It is presumed that copper and Cu₈S₅ are present at an end portion of the sectional surface in the vicinity of the surface of the produced sample.

The sectional surface of the sample alloy S1 according to Example 3 was observed with a scanning electron microscope (SEM), and the iron phase (parent phase) and grain boundary phase on the observed surface were each measured for an electrical resistance value between a pair of tungsten probes each having a fine tip by applying the probes onto the phases. The tungsten probes used for the measurement of the electrical resistance value are shown in FIG. 19. It should be noted that the distance between the pair of tungsten probes was measured to be about from 1 μm to 2 μm based on scars formed by the tungsten probes at the time of the measurement of the electrical resistance.

By using the above-mentioned pair of tungsten probes, the iron phase and the grain boundary phase were each measured for the electrical resistance value at three different positions. The measurement results for the electrical resistance value of the iron phase were 4.6Ω, 4.3Ω, and 4.1Ω. In contrast, the measurement results for the electrical resistance value of the grain boundary phase were 618Ω, 702Ω, and 624Ω. From those results, it is revealed that the grain boundary phase has a significantly high electrical resistance value as compared to the iron phase (parent phase). Therefore, it can be determined that the sample alloy S1 according to Example 3 exhibits a function of blocking an eddy current caused by an alternating-current magnetic field by virtue of the grain boundary phase having a high electrical resistance value when being utilized for a core of a reactor or the like.

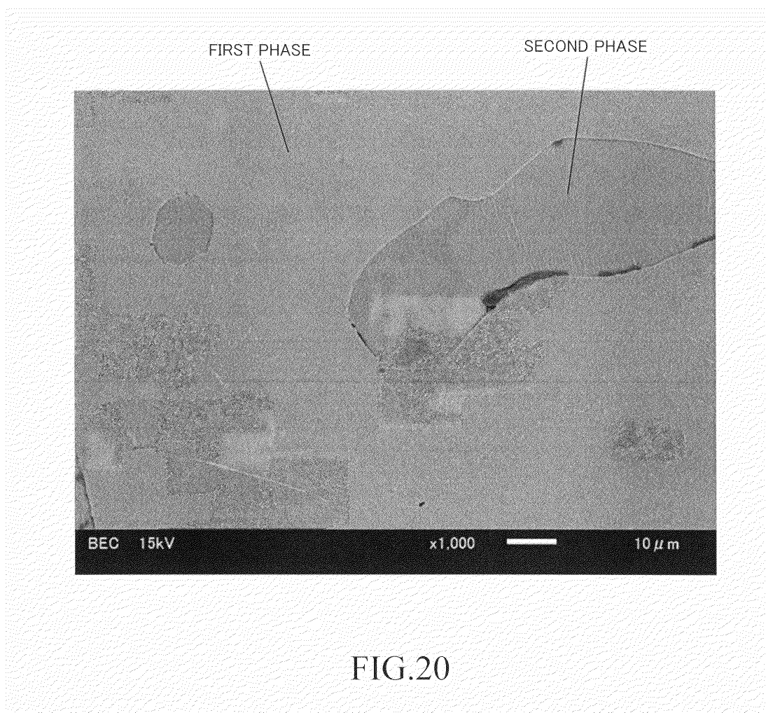

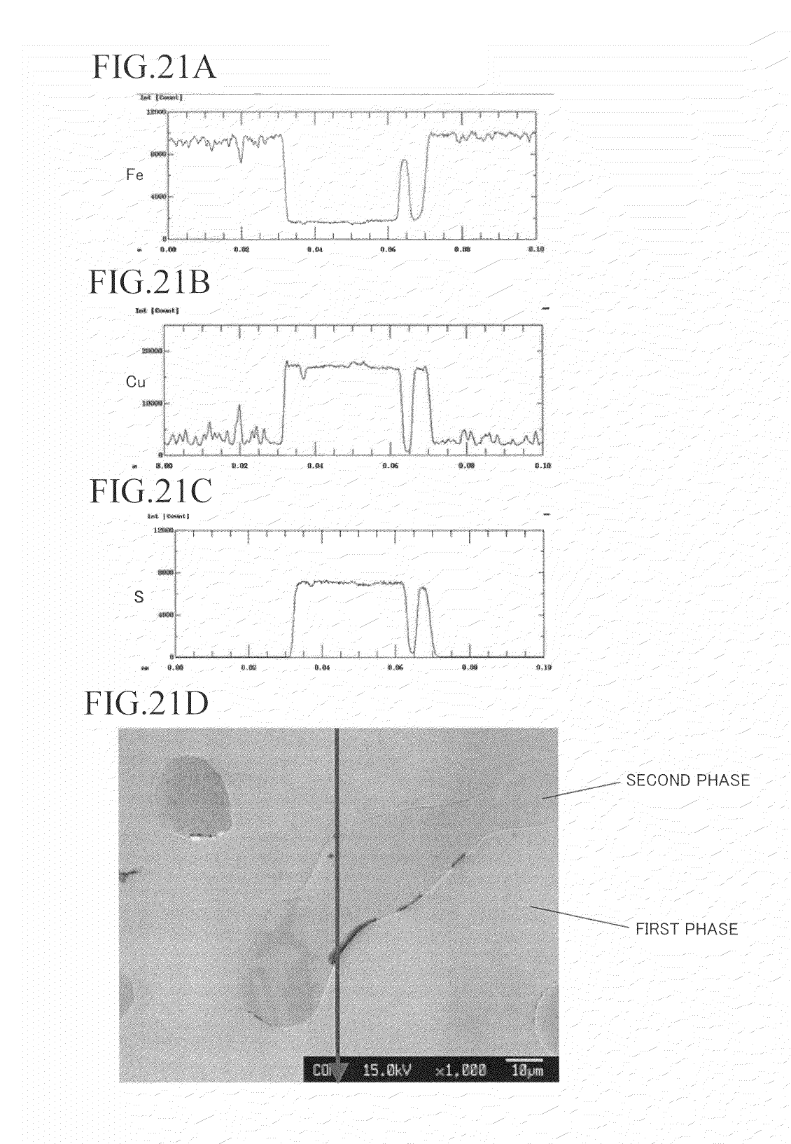

FIG. 20 is a BSE image of a sectional surface of the sample alloy S2 according to Comparative Example 2 with a SEM. FIG. 21A, FIG. 21B, and FIG. 21C are line analysis results of the sectional surface of the sample alloy S2 according to Comparative Example 2 with an electron probe microanalyzer (EPMA). FIG. 21A is a line analysis result of iron (Fe), FIG. 21B is a line analysis result of copper (Cu), and FIG. 21C is a line analysis result of sulfur (S). It should be noted that FIG. 21D is an image for showing the sectional surface of the sample alloy S2 used for obtaining the line analysis results shown in FIG. 21A, FIG. 21B, and FIG. 21C together with a scanning line. As shown in FIG. 20, also in Comparative Example 2, a first phase in which mainly iron (Fe) is detected and a second phase in which mainly copper (Cu) and sulfur (S) are detected are observed, as in Example 3. The first phase forms the parent phase.

However, the second phase in which mainly copper (Cu) and sulfur (S) are detected is not formed so as to surround the crystal grains of iron constituting the first phase but crystallized out in a particle form in the parent phase. The component elements of the second phase crystallized out in a particle form in the parent phase are iron, copper, and sulfur, and the atomic concentrations of these elements are roughly in agreement with the atomic concentrations of iron, copper, and sulfur in the grain boundary phase of the sample alloy S1 according to Example 3. Accordingly, the second phase crystallized out in a particle form is presumed to have a composition of Cu₅FeS₄. Therefore, the second phase is considered to have a high electrical resistance value. However, it is considered that the sample alloy S2 cannot sufficiently block an eddy current caused by an alternating-current magnetic field owing to the second phase being not formed so as to surround the crystal grains containing iron as a main component (parent phase) when being utilized for a core of a reactor or the like.

In Comparative Example 2, the rapid cooling start temperature is 988° C., which is lower than that in Example 3. In this case, the solidification of the grain boundary phase is completed before the start of the rapid cooling. Accordingly, the grain boundary phase shrinks by its own surface tension to be formed into a spherical shape in the course of the solidification before the rapid cooling. Therefore, it is considered that, even if the rapid cooling is performed thereafter, the grain boundary phase cannot form such a structure as to surround the parent phase owing to its spherical shape.

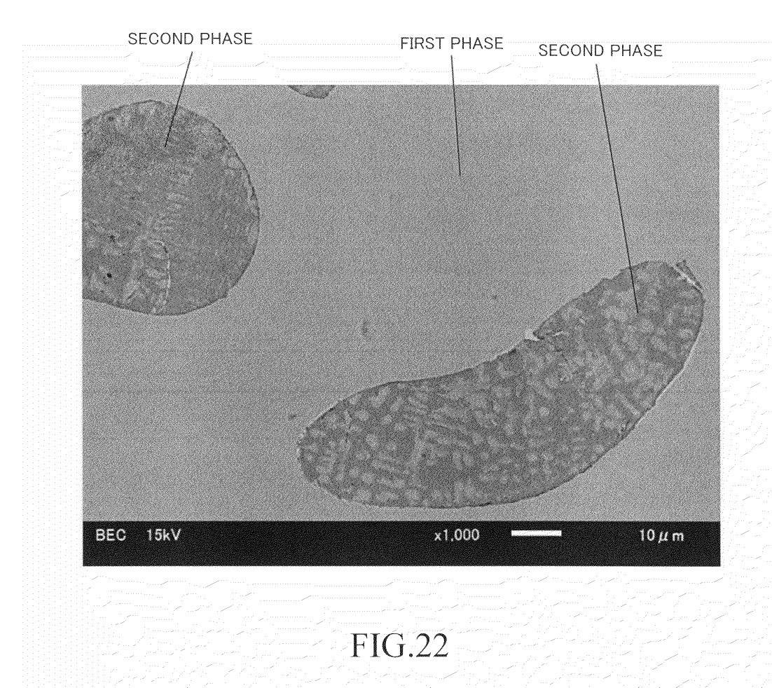

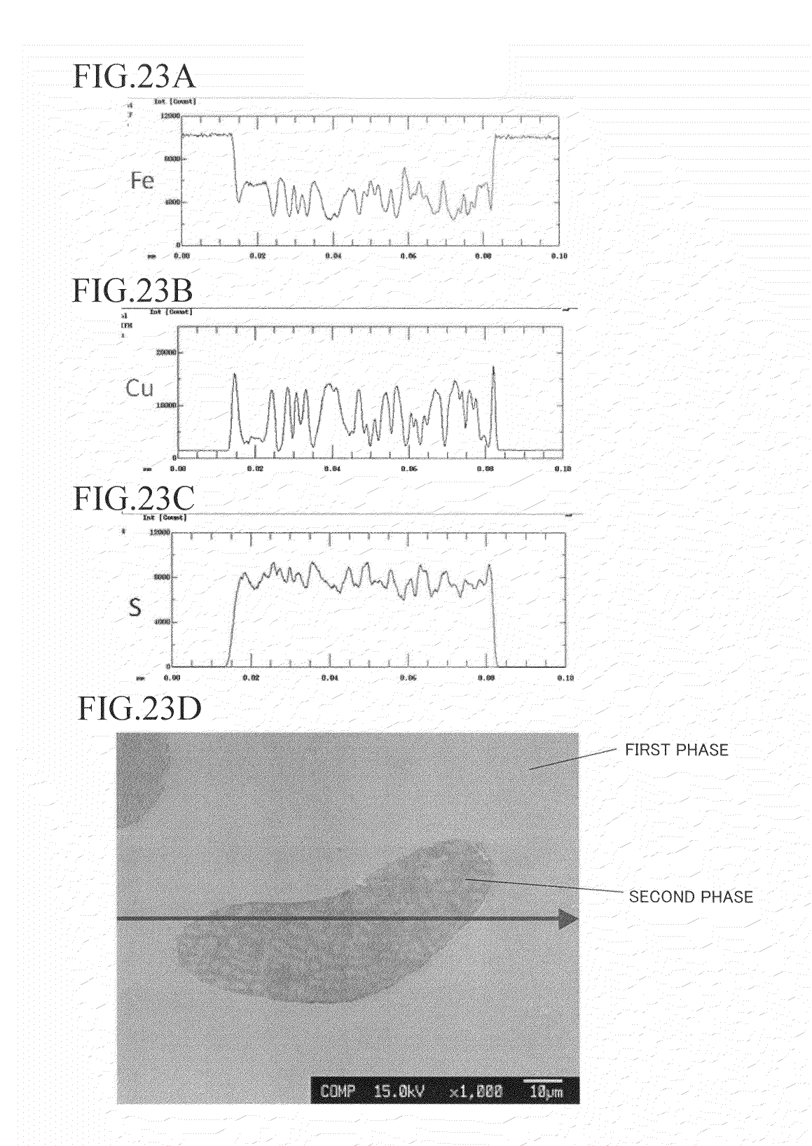

FIG. 22 is a BSE image of a sectional surface of the sample alloy S3 according to Comparative Example 3 with a SEM. FIG. 23A, FIG. 23B, and FIG. 23C are line analysis results of the sectional surface of the sample alloy S3 according to Comparative Example 3 with an electron probe microanalyzer (EPMA). FIG. 23A is a line analysis result of iron (Fe), FIG. 23B is a line analysis result of copper (Cu), and FIG. 23C is a line analysis result of sulfur (S). It should be noted that FIG. 23D is an image for showing the sectional surface of the sample alloy S3 used for obtaining the line analysis results shown in FIG. 23A, FIG. 23B, and FIG. 23C together with a scanning line. As shown in FIG. 22, also in Comparative Example 3, a first phase and a second phase are observed, as in Example 3.

The main component of the first phase of the sample alloy S3 according to Comparative Example 3 is iron. The first phase forms the parent phase. The second phase is crystallized out in the parent phase (first phase). In addition, a region having a high concentration of copper is formed at an interface between the first phase and the second phase. Therefore, the second phase has a low surface resistance. In addition, the concentration of sulfur is almost uniform inside the second phase. However, a region having a high concentration of copper and a low concentration of iron and a region having a high concentration of iron and a low concentration of copper are present inside the second phase (see FIG. 23A and FIG. 23B). The former is considered to be a copper sulfide such as Cu₂S or Cu₈S₅ and have a high resistance value, but the latter is considered to be an iron sulfide (FeS) and have a low resistance value. From the analysis results shown in FIG. 23A, FIG. 23B, and FIG. 23C, it is considered that a white portion around the second phase shown in FIG. 22 is copper, a dark portion in the second phase is FeS, and a light portion in the second phase is a copper sulfide. In addition, as is apparent from FIG. 22, FeS constituting the dark portion in the second phase forms a matrix of the second phase. Therefore, the second phase as a whole has a low resistance value. As a result, it is considered that the sample alloy S3 having formed therein such phase cannot sufficiently block an eddy current caused by an alternating-current magnetic field when being utilized for a core of a reactor or the like, as with Comparative Example 2.

### VARIATION EXAMPLE 1 OF RAPID COOLING STEP

In the third embodiment, an example in which the melted raw materials are rapidly cooled by using a vertical tubular furnace is shown, but the melted raw materials may be rapidly cooled by other methods. For example, the melted raw materials may be rapidly cooled by using a mold. In this case, the raw materials are heated to around 1,500° C. to be completely melted, and the molten alloy obtained by the melting is poured into a mold heated to a temperature equal to or higher than the rapid cooling start temperature. After that, the molten alloy is retained until the molten alloy in the mold is cooled to the rapid cooling start temperature at which the molten alloy is in a semi-solidified state by adjusting the mold temperature, leaving the molten alloy to be naturally cooled, or blowing an inert gas, mist, or the like to the surface of the mold. At the time when the molten alloy is cooled to the rapid cooling start temperature, the mold is put in water or oil, or a gas or mist at low temperature is blown in a large amount to the surface of the mold. The alloy in the mold may be rapidly cooled also by such method. Such method can simplify a subsequent processing step by matching of a cavity shape in the mold to a product shape. In addition, such method can simplify a subsequent assembling step by insertion of another part in the mold.

### VARIATION EXAMPLE 2 OF RAPID COOLING STEP

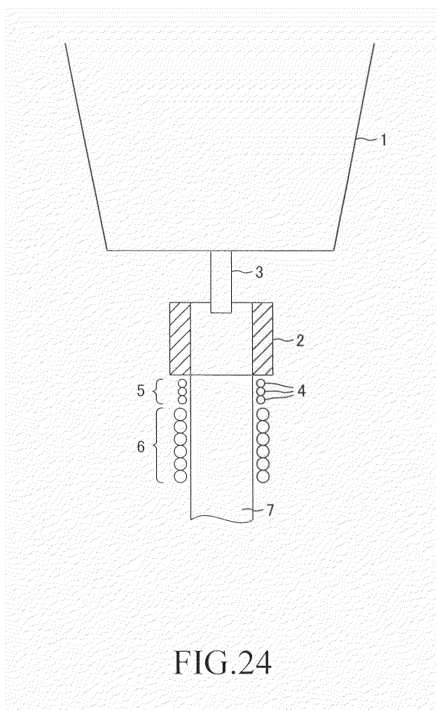

FIG. 24 is a schematic view for illustrating an example of a production apparatus to be used for production of the iron-based soft magnetic material according to the third embodiment by continuous casting. In the case of using the production apparatus illustrated in FIG. 24, first, the melted raw materials are put in a tundish 1, and the raw materials in the tundish 1 are then poured into a casting mold 2 through an immersion nozzle 3. In the casting mold 2, the raw materials are cooled to the rapid cooling start temperature while being extrusion molded. The raw materials form a liquid phase near the inlet of the casting mold 2, but part of the iron phase in the raw materials is solidified near the outlet of the casting mold 2 because the raw materials are cooled by the casting mold 2 when passing through the casting mold 2. In contrast, the grain boundary phase forms a liquid phase. Accordingly, near the outlet of the casting mold 2, the raw materials are in a phase state of a solid-liquid coexistence state, that is, a semi-solidified state. In a preferred form of such solid-liquid coexistence state, a solidified iron phase is desirably crystallized out so as to float in a cell form in the molten alloy. In order to promote the crystallization of the iron phase in the molten alloy, the molten alloy in the casting mold 2 may be magnetically stirred.

The raw materials in a solid-liquid coexistence state discharged from the casting mold 2 are rapidly cooled in a rapid cooling zone 5. With this, the grain boundary phase is uniformly solidified. In the rapid cooling zone 5, the raw materials are rapidly cooled by, for example, spraying cooling water from a mist spray. It should be noted that the raw materials are easily deformed in a semi-solidified state before being completely solidified. Therefore, the shape of the raw materials is retained by a support roll 4 provided in the rapid cooling zone 5. In addition, in the case where a molded product is a core part in a toroidal form, the molded product is desirably continuously cast into a hollow pipe form. In this case, it is desired that the molded product be cooled not only from an outer peripheral side of the product in a hollow pipe form but also from an inner peripheral side (hollow portion side) thereof. In the rapid cooling zone 5, the raw materials are cooled to such a temperature that the solidification of the grain boundary phase is completed, for example, around 860° C. After that, the raw materials are cooled by normal cooling in a cooling zone 6 to a temperature that permits handling. Thus, a cast piece 7 of the iron-based soft magnetic material according to the third embodiment is continuously cast molded. In order to improve the magnetic property of the iron phase in the cast piece 7, a zone for maintaining the temperature of the cast piece 7 at a magnetic annealing temperature (around from 600° C. to 800° C.) may be provided in the cooling zone 6.

Next, application examples of the iron-based soft magnetic material according to any one of the above-mentioned embodiments are described. The iron-based soft magnetic material according to any one of the above-mentioned embodiments is hereinafter referred to simply as iron-based soft magnetic material according to the embodiment. FIG. 5 is a schematic perspective view of a toroidal core 10, which is an iron-based soft magnetic core produced by using the the iron-based soft magnetic material according to the embodiment. The core having such shape is often used as a choke coil or the like. As a typical core using a related-art iron-based soft magnetic material, there is given, for example, a laminate core formed by laminating magnetic steel sheets, a green compact core formed of a molded article of a green compact compressed under high pressure, or a dust core formed by binding magnetic powder with a binder such as a resin. However, the dust core has disadvantages of low maximum magnetization owing to the binder and high core temperature owing to heat of the magnetic powder being accumulated inside. The laminate core has such a limitation that a magnetic field needs to be applied in parallel to the surfaces of the magnetic steel sheets, and has a disadvantage of a difficulty in obtaining a complex shape in which its sectional surface shape changes in the surface direction of the steel sheets. Further, also the green compact core has a disadvantage in that it is difficult to form the core into a shape in which its sectional surface shape changes. In contrast, the iron-based soft magnetic core produced by cast molding of the iron-based soft magnetic material according to the embodiment does not contain a binder or the like, has low anisotropy in magnetic characteristics, and can be formed into a free shape by pouring the molten alloy into a mold including various cavities. Therefore, the iron-based soft magnetic core to be provided can exhibit additionally excellent performance as compared to the related-art cores and achieve a low production cost.

As mentioned above, one embodiment of this disclosure provides an iron-based soft magnetic material, including: a parent phase containing iron as a main component; and a grain boundary phase present in a crystal grain boundary of the parent phase, the grain boundary phase containing as a main component a sulfide containing copper. In this case, it is preferable that the parent phase includes at least one selected from the group consisting of pure iron, an iron-silicon alloy, an iron-cobalt alloy, an iron-aluminum alloy, an iron-silicon-aluminum alloy, and an iron-nickel alloy. In addition, it is preferable that the grain boundary phase include at least one selected from the group consisting of Cu₂S, Cu₅FeS₄, and CuFeS₂, and sulfides represented by molecular formulae in which one of iron and copper is lost from Cu₂S, Cu₅FeS₄, and CuFeS₂. Examples of the sulfides represented by molecular formulae in which one of iron and copper is removed from Cu₂S, Cu₅FeS₄, and CuFeS₂ may include Cu_{1.96}S, Cu₃₁S₁₆, Cu₇S₄, Cu₉S₅, CuS, CuS₂, CuFe₂S₃, Cu₃FeS₈, Cu₅FeS₆, and Cu₈Fe₉S₁₆.

It is preferable that the iron-based soft magnetic material have a content ratio of a constituent component of the parent phase of 70 at % or more and 98.5 at % or less. In addition, it is preferable that the iron-based soft magnetic material have a ratio α(S/Cu) of 0.5 or more and 2.0 or less. Here, the ratio α(S/Cu) represents a ratio of an atomic concentration of sulfur to an atomic concentration of copper. That is, it is desired that the ratio be copper:sulfur=1:2-2:1 in terms of atomic concentration. Furthermore, it is preferable that the iron-based soft magnetic material have a combination of content ratios of iron and a constituent component of the parent phase other than iron (Fe+β), copper (Cu), and sulfur (S) in a region bounded by a point A representing 70 at % (Fe+β)-20 at % Cu-10 at % S, a point B representing 77.5 at % (Fe+β)-7.5 at % Cu-15 at % S, a point C representing 98 at % (Fe+β)-1.33 at % Cu-0.67 at % S, and a point D representing 98.5 at % (Fe+β)-0.5 at % Cu-1.0 at % S in a ternary composition diagram of atomic concentrations of iron and the constituent component of the parent phase other than iron (Fe+β), copper (Cu), and sulfur (S).

The iron-based soft magnetic material according to the embodiment of this disclosure includes the parent phase and the grain boundary phase present in the crystal grain boundary of the parent phase (a boundary between crystal grains constituting the parent phase). The magnetic characteristics of the iron-based soft magnetic material can be sufficiently improved by virtue of the parent phase containing as a main component iron having excellent magnetic characteristics. On the other hand, the electrical resistance (specific resistance) of the iron-based soft magnetic material can be increased by virtue of the grain boundary phase containing as a main component the sulfide containing copper. Therefore, the iron-based soft magnetic material to be provided can exhibit sufficient magnetic characteristics and sufficiently reduce an eddy current loss.

The above-mentioned iron-based soft magnetic material according to the embodiment of this disclosure is desirably produced by melting iron, copper, sulfur, and as required the constituent component of the parent phase other than iron, followed by casting. With this, first, iron, which has the highest melting point, precipitates as the parent phase in the casting and cooling and solidification of a molten alloy containing iron, copper, sulfur, and as required the constituent component of the parent phase other than iron. After that, as the cooling proceeds, the sulfide containing copper precipitates so as to surround the crystal grains of iron serving as the parent phase. Accordingly, the sulfide containing copper is formed in the crystal grain boundary of the parent phase. In this manner, the iron-based soft magnetic material including: the parent phase containing iron as a main component; and the grain boundary phase present in the crystal grain boundary of the parent phase, the grain boundary phase containing as a main component the sulfide containing copper, is produced.

It is preferable that the parent phase contains silicon. In this case, it is preferable that the parent phase have a content ratio (atomic concentration) of silicon of 3.8 at % or more and 19.5 at % or less. More preferably, it is desired that the parent phase have a content ratio (atomic concentration) of silicon of 3.8 at % or more and 10 at % or less.

When the parent phase contains silicon, generation of cracks can be prevented in the grain boundary phase, the cracks resulting from fine iron arising in the parent phase in cast molding of the iron-based soft magnetic material. As a result, the iron-based soft magnetic material to be provided can exhibit high mechanical strength.

The iron-based soft magnetic material according to the embodiment of this disclosure is desirably produced by melting a raw material for the parent phase containing iron as a main component and a raw material for the grain boundary phase containing as a main component the sulfide containing copper by heating, followed by rapid cooling at a cooling rate of 10° C./sec or more. That is, a method of producing the iron-based soft magnetic material according to the embodiment of this disclosure desirably includes: a melting step of melting the raw material for the parent phase containing iron as a main component and the raw material for the grain boundary phase containing as a main component the sulfide containing copper by heating; and a rapid cooling step of rapidly cooling the melted raw material for the parent phase and raw material for the grain boundary phase at a cooling rate of 10° C./sec or more. With this, the grain boundary phase is rapidly cooled and solidified, and hence the grain boundary phase can form a uniform single phase. That is, the grain boundary phase can be single phased. Herein, the cooling rate in the rapid cooling step means an average cooling rate up to completion of the solidification of the raw materials through the rapid cooling step.

In this case, in a case where the temperature of the melted raw material for the parent phase and raw material for the grain boundary phase at the time when the rapid cooling of those raw materials is started exceeds 1,400° C., that is, a rapid cooling start temperature exceeds 1,400° C., the content of iron is increased in the grain boundary phase, and hence FeS precipitates in the grain boundary phase, resulting in a reduction in specific resistance of the grain boundary phase. Besides, the volume fraction of the grain boundary phase is increased, resulting in a reduction in maximum magnetization of the iron-based soft magnetic material. For the above-mentioned reasons, the rapid cooling start temperature is desirably 1,400° C. or less. In addition, when the rapid cooling start temperature is less than 1,000° C., the solidification of the grain boundary phase is completed before the start of the rapid cooling. Accordingly, the grain boundary phase shrinks by its own surface tension to be formed into a spherical shape in the course of the solidification before the rapid cooling. Therefore, even if the rapid cooling is performed thereafter, the grain boundary phase cannot form such a structure as to surround the parent phase owing to its spherical shape. In addition, in the course of the solidification before the rapid cooling, a liquid phase constituting the grain boundary phase is separated into two phases. FeS and Cu are crystallized out from the respective structures of the liquid phases separated into two phases. As a result, FeS or Cu is present in the grain boundary phase, resulting in a reduction in specific resistance of the grain boundary phase. For the above-mentioned reasons, the rapid cooling start temperature is preferably 1,000° C. or more. Accordingly, it is preferable that the rapid cooling start temperature be 1,000° C. or more and 1,400° C. or less.

In the case where the iron-based soft magnetic material according to the embodiment of this disclosure is produced through the above-mentioned melting step and rapid cooling step, it is preferable that the iron-based soft magnetic material have a combination of content ratios of iron and a constituent component of the parent phase other than iron (Fe+β), copper, and sulfur in a region bounded by a point E representing 70 at % (Fe+β)-20 at % Cu-10 at % S, a point F representing 74 at % (Fe+β)-13 at % Cu-13 at % S, a point G representing 88 at % (Fe+β)-6 at % Cu-6 at % S, and a point H representing 89.5 at % (Fe+β)-7 at % Cu-3.5 at % S in a ternary composition diagram of atomic concentrations of iron and the constituent component of the parent phase other than iron (Fe+β), copper, and sulfur.

When the concentration of iron in the iron-based soft magnetic material is higher than the concentration of iron represented by combinations in the region, or when the concentration of sulfur in the iron-based soft magnetic material is higher than the concentration of sulfur represented by combinations in the region, a FeS phase having a low resistance is crystallized out in the grain boundary phase. As a result, the specific resistance of the grain boundary phase is reduced. In addition, when the concentration of copper in the iron-based soft magnetic material is higher than the concentration of copper represented by combinations in the region, a copper solid solution having a low resistance is crystallized out in the grain boundary phase. As a result, the specific resistance of the grain boundary phase is reduced. Further, when the concentration of iron in the iron-based soft magnetic material is lower than the concentration of iron represented by combinations in the region, the volume ratio of the grain boundary phase to the parent phase is increased. As a result, the maximum magnetization is reduced.

In contrast, when the iron-based soft magnetic material has a composition of its constituent components represented by combinations in the region, copper and FeS are prevented from being crystallized out in the grain boundary phase. In addition, the reduction in maximum magnetization resulting from a lack of the content of iron in the parent phase can be prevented by virtue of a moderate concentration of iron in the iron-based soft magnetic material. Further, through the rapid cooling of the grain boundary phase, the grain boundary phase forms a uniform phase (single phase), and is formed only of, for example, Cu₅FeS₄ having a high resistance. Accordingly, the iron-based soft magnetic material to be provided can exhibit sufficiently high maximum magnetization and a high resistance value.

According to another embodiment of this disclosure, there is provided an iron-based soft magnetic core including the iron-based soft magnetic material having the above-mentioned construction. With this, the iron-based soft magnetic core to be provided can exhibit excellent magnetic characteristics and a sufficiently reduced eddy current loss.

The embodiments of the present invention are described above, but the present invention should not be limited to the embodiments described above. For example, the combination of the content ratios (atomic concentrations) of iron and the constituent component of the parent phase other than iron (for example, silicon), copper, and sulfur only needs to be a combination in a region bounded by the points A, B, C, and D in FIG. 1 or FIG. 8. In addition, in the case of producing the iron-based soft magnetic material by rapid cooling and solidifying the raw materials, the combination of the content ratios (atomic concentrations) of iron and the constituent component of the parent phase other than iron, copper, and sulfur only needs to be a combination in a region bounded by the points E, F, G, and H in FIG. 15. Further, the parent phase may be formed of pure iron, iron-silicon alloy, an iron-cobalt alloy, an iron-aluminum alloy, an iron-silicon-aluminum alloy, or an iron-nickel alloy. In addition, the main component of the grain boundary phase only needs to be a sulfide containing copper, and in particular, only needs to be at least one selected from the group consisting of Cu₂S, Cu₅FeS₄, CuFeS₂, and sulfides represented by molecular formulae in which iron or copper is lost from Cu₂S, Cu₅FeS₄, and CuFeS₂. Thus, the present invention can be modified as long as the modification does not deviate from the gist of the present invention.

What is claimed is:

1. An iron-based soft magnetic material, comprising:
a parent phase containing iron as a main component; and
a grain boundary phase present in a crystal grain boundary of the parent phase, the grain boundary phase containing as a main component a sulfide containing copper.

2. An iron-based soft magnetic material according to claim 1, wherein the parent phase comprises at least one selected from the group consisting of pure iron, an iron-silicon alloy, an iron-cobalt alloy, an iron-aluminum alloy, an iron-silicon-aluminum alloy, and an iron-nickel alloy.

3. An iron-based soft magnetic material according to claim 1, wherein the parent phase contains silicon.

4. An iron-based soft magnetic material according to claim 3, wherein the parent phase has a content ratio of silicon of 3.8 at % or more and 19.5 at % or less.

5. An iron-based soft magnetic material according to claim 4, wherein the parent phase has a content ratio of silicon of 3.8 at % or more and 10 at % or less.

6. An iron-based soft magnetic material according to claim 1, wherein the grain boundary phase comprises at least one selected from the group consisting of Cu₂S, Cu₅FeS₄, and CuFeS₂, and sulfides represented by molecular formulae in which one of iron and copper is lost from Cu₂S, Cu₅FeS₄, and CuFeS₂.

7. An iron-based soft magnetic material according to claim 1, wherein the iron-based soft magnetic material has a content ratio of a constituent component of the parent phase of 70 at % or more and 98.5 at % or less.

8. An iron-based soft magnetic material according to claim 1, wherein the iron-based soft magnetic material has a ratio α(S/Cu) of 0.5 or more and 2.0 or less, the ratio α(S/Cu) representing a ratio of an atomic concentration of sulfur to an atomic concentration of copper.

9. An iron-based soft magnetic material according to claim 1, wherein the iron-based soft magnetic material has a combination of content ratios of iron and a constituent component of the parent phase other than iron (Fe+β), copper, and sulfur in a region bounded by a point A representing 70 at % (Fe+β)-20 at % Cu-10 at % S, a point B representing 77.5 at % (Fe+β)-7.5 at % Cu-15 at % S, a point C representing 98 at % (Fe+β)-1.33 at % Cu-0.67 at % S, and a point D representing 98.5 at % (Fe+β)-0.5 at % Cu-1.0 at % S in a ternary composition diagram of atomic concentrations of iron and the constituent component of the parent phase other than iron (Fe+β), copper, and sulfur.

10. An iron-based soft magnetic material according to claim 1, wherein the iron-based soft magnetic material is produced by melting a raw material for the parent phase and a raw material for the grain boundary phase by heating, followed by rapid cooling at a cooling rate of 10° C./sec or more.

11. An iron-based soft magnetic material according to claim 10, wherein a rapid cooling start temperature in the rapid cooling of the melted raw material for the parent phase and raw material for the grain boundary phase is 1,000° C. or more and 1,400° C. or less.

12. An iron-based soft magnetic material according to claim 10, wherein the grain boundary phase comprises at least one selected from the group consisting of Cu₂S, Cu₅FeS₄, and CuFeS₂, and sulfides represented by molecular formulae in which one of iron and copper is lost from Cu₂S, Cu₅FeS₄, and CuFeS₂.

13. An iron-based soft magnetic material according to claim 10, wherein the iron-based soft magnetic material has a combination of content ratios of iron and a constituent component of the parent phase other than iron (Fe+β), copper, and sulfur in a region bounded by a point E representing 70 at % (Fe+β)-20 at % Cu-10 at % S, a point F representing 74 at % (Fe+β)-13 at % Cu-13 at % S, a point G representing 88 at % (Fe+β)-6 at % Cu-6 at % S, and a point H representing 89.5 at % (Fe+β)-7 at % Cu-3.5 at % S in a ternary composition diagram of atomic concentrations of iron and the constituent component of the parent phase other than iron (Fe+β), copper, and sulfur.

14. An iron-based soft magnetic core, comprising the iron-based soft magnetic material of claim 1.
